(19) United States
(12) Patent Application Publication
(10) Pub. No.: US 2026/0270574 A1
(43) Pub. Date: Sep. 10, 2026

(54) SENSOR DEVICE AND METHOD FOR OPERATING A SENSOR DEVICE

(71) Applicant: Sony Semiconductor Solutions Corporation, Kanagawa (JP)

(72) Inventors: Valery VISHNEVSKIY, Stuttgart (DE); Diederik Paul MOEYS, Stuttgart (DE); Gregory BURMAN, Stuttgart (DE); Sebastian KOZERKE, Stuttgart (DE)

(73) Assignee: Sony Semiconductor Solutions Corporation, Kanagawa (JP)

(21) Appl. No.: 19/165,592

(22) PCT Filed: Mar. 7, 2024
(86) PCT No.: PCT/EP2024/055951

§ 371 Date: Sep. 16, 2025

(30) Foreign Application Priority Data
Mar. 24, 2023 (EP) 23163900.6

(51) Int. Cl. H04N 25/47

(52) U.S. Cl. CPC H04N 25/47

(57) ABSTRACT

A sensor device comprises a measurement unit configured to make measurements based on measurement parameters, wherein measuring the same quantity with different parameters yields different measurement results. A control unit varies the measurement parameters over time according to a predetermined variation pattern during measurement operations. A storage unit stores multiple temporal series of measurement results, each series representing measurements made with the predetermined variation pattern in different measurement situations. The control unit compares current measurements made with the predetermined variation pattern against the stored temporal series of measurement results. When the current measurements match one of the stored temporal series, the control unit identifies the measurement situation associated with the matching stored temporal series as the current measurement situation.

### FIELD OF THE INVENTION

The present technology relates to a sensor device and a method for operating a sensor device, in particular, to a sensor device and a method for operating a sensor device that allows an improved identification of measurement situations.

### BACKGROUND

In imaging systems like active pixel sensors, APS, and dynamic/event vision sensors, DVS/EVS, readout parameters are tuned to achieve optimal image quality for a particular acquisition setup and scene. Such an approach forces a user to make a hard choice of sensor parameters before recording a scene, which leads in turn to a loss of information that could in principle be captured.

This issue is even more pronounced when the scene is diverse in contrast and actions, as is e.g. the case for high dynamic range, slow and fast moving objects, and the like. In addition, single, fixed sensor parameters would inevitably compromise the overall quality of the acquired data in a single sensor setup.

This problem can be addressed by using temporally varying sensor/measurement parameters and by reconstructing an image from measurement results obtained for the different measurement parameters. However, image reconstruction can be complex in this situation.

Further, the problem of restriction of measurement parameters to specific ranges applies to various measurements.

Also here, temporally varying measurement parameters can be applied, leading however, to the same problem of increased complexity in interpreting the measurement results.

Improved sensor devices and methods for operating these sensor devices are therefore desirable that mitigate the above problems.

### SUMMARY OF INVENTION

To this end, a sensor device is provided that comprises a measurement unit that is configured to make measurements based on measurement parameters, wherein measuring the same quantity twice with different parameters may yield different measurement results, a control unit that is configured to vary the measurement parameters over time according to a predetermined variation pattern while the measurement unit makes measurements, and a storage unit that is configured to store a plurality of temporal series of measurement results, wherein different temporal series represent measurements made with the predetermined variation pattern of measurement parameters in different measurement situations. Here, the control unit is configured to compare measurements made by the measurement unit with the predetermined variation pattern of measurement parameters and the stored plurality of temporal series of measurement results, and, if said measurements match one of the stored temporal series of measurement results, to identify the measurement situation of the one stored temporal series of measurement results as the measurement situation of the measurements made by the measurement unit.

Further, a method for operating a sensor device is provided, which method comprises: by a measurement unit, making measurements based on measurement parameters, wherein measuring the same quantity twice with different measurement parameters may yield different measurement results; by a control unit, varying the measurement parameters over time according to a predetermined variation pattern while the measurement unit makes measurements; storing in a storage unit a plurality of temporal series of measurement results, wherein different temporal series represent measurements made with the predetermined variation pattern of measurement parameters in different measurement situations, and by the control unit, comparing measurements made by the measurement unit with the predetermined variation pattern of measurement parameters and the stored plurality of temporal series of measurement results, and, if said measurements match one of the stored temporal series of measurement results, identifying the measurement situation of the one stored temporal series of measurement results as the measurement situation of the measurements made by the measurement unit.

By using varying measurement parameters missing information due to unduly restricted measurement settings is avoided. To reduce the complexity of processing of the measurement data obtained in this manner, measurements are performed (or simulated) previously in various measurement situations of interest while using the same variation of the measurement parameters. The results of these measurements are stored and can be compared with the actual measurements. This allows recognition of specific measurement situations if a match between actual measurements and the stored series of measurement results can be detected. This knowledge about the measurement situation simplifies post processing of the actual measurement results. Thus, energy consumption of the post processing is reduced, and its reliability is enhanced.

### BRIEF DESCRIPTION OF DRAWINGS

FIG. 1 is a schematic diagram of a sensor device.

FIG. 2 is a schematic block diagram of a sensor section.

FIG. 3 is a schematic block diagram of a pixel array section.

FIG. 4 is a schematic circuit diagram of a pixel block.

FIG. 5 is a schematic block diagram illustrating of an event detecting section.

FIG. 6 is a schematic circuit diagram of a current-voltage converting section.

FIG. 7 is a schematic circuit diagram of a subtraction section and a quantization section.

FIG. 8 is a schematic diagram of a frame data generation method based on event data.

FIG. 9 is a schematic block diagram of another quantization section.

FIG. 10 is a schematic diagram of another event detecting section.

FIG. 11 is a schematic block diagram of another pixel array section.

FIG. 12 is a schematic circuit diagram of another pixel block.

FIG. 13 is a schematic block diagram of a scan-type sensor device.

FIG. 14 is a schematic block diagram of a sensor device.

FIG. 15 is a schematic block diagram of another sensor device.

FIG. 16 is a schematic diagram showing a variation of a measurement parameter.

FIG. 17 is a schematic illustration showing variations of measurement parameters.

FIG. 18 is a schematic illustration showing the generation of varying measurement parameters.

FIG. 19 is another schematic illustration showing the generation of varying measurement parameters.

FIG. 20 is a schematic illustration showing the generation of time series of measurement results.

FIG. 21 is a schematic illustration showing encoding of measurement results.

FIG. 22 is a schematic illustration of a sensor system.

FIG. 23 illustrates schematically a process flow of a machine learning process executed by the sensor system.

FIG. 24 illustrates schematically a process flow of a method for operating a sensor device.

FIG. 25 is a schematic block diagram of a vehicle control system.

FIG. 26 is a diagram of assistance in explaining an example of installation positions of an outside-vehicle information detecting section and an imaging section.

FIGS. 27A and 27B are schematic illustrations of a mobile device and a head mounted display comprising a sensor device.

### DETAILED DESCRIPTION

The present disclosure is directed to mitigating problems occurring in sensor devices in which measurements need to be optimized for different measurement conditions by adjusting respective measurement parameters. The solutions to these problems discussed below are applicable to all according sensor types. They are particularly relevant for asynchronously operating sensor devices such as event based/dynamic vision sensors, EVS/DVS, silicon cochlea devices or single photon avalanche diode, SPAD, devices. However, in order to ease the description and also in order to cover an important application example, the present description is focused without prejudice on EVS/DVS. Further, it has to be understood that although in the following reference will be made to the circuitry of EVS/DVS, the discussed solutions can be applied in principle to all pixel-based sensor devices. The discussed sensor devices may be implemented in any imaging sensor setup such as e.g. smartphone cameras, scientific devices, automotive video sensors or the like.

First, a possible implementation of a EVS/DVS will be described. This is of course purely exemplary. It is to be understood that EVSs/DVSs could also be implemented differently.

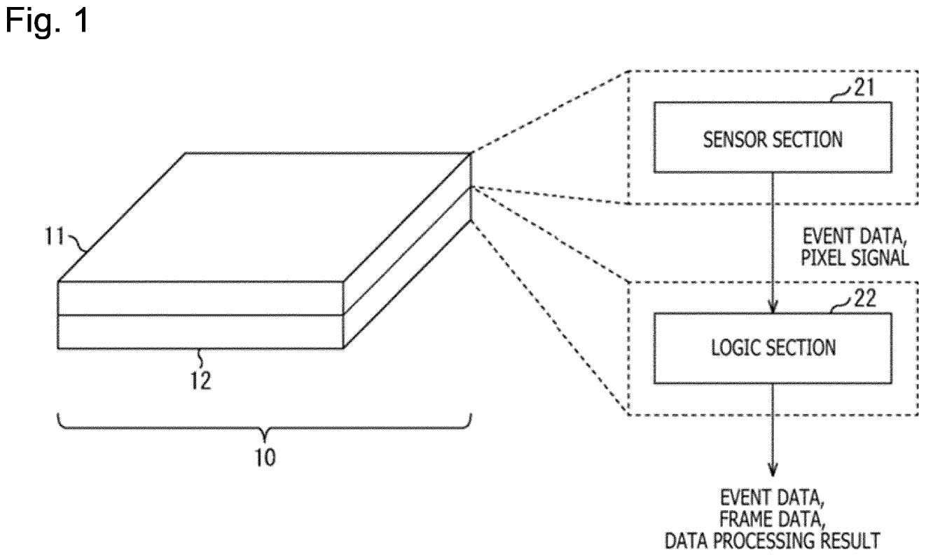

FIG. 1 is a diagram illustrating a configuration example of a sensor device 10, which is in the example of FIG. 1 constituted by a sensor chip.

The sensor device 10 is a single-chip semiconductor chip and includes a sensor die (substrate) 11, which serves as a plurality of dies (substrates), and a logic die 12 that are stacked. Note that, the sensor device 10 can also include only a single die or three or more stacked dies.

In the sensor device 10 of FIG. 1, the sensor die 11 includes (a circuit serving as) a sensor section 21, and the logic die 12 includes a logic section 22. Note that, the sensor section 21 can be partly formed on the logic die 12. Further, the logic section 22 can be partly formed on the sensor die 11.

The sensor section 21 includes pixels configured to perform photoelectric conversion on incident light to generate electrical signals, and generates event data indicating the occurrence of events that are changes in the electrical signal of the pixels. The sensor section 21 supplies the event data to the logic section 22. That is, the sensor section 21 performs imaging of performing, in the pixels, photoelectric conversion on incident light to generate electrical signals, similarly to a synchronous image sensor, for example. The sensor section 21, however, generates event data indicating the occurrence of events that are changes in the electrical signal of the pixels instead of generating image data in a frame format (frame data). The sensor section 21 outputs, to the logic section 22, the event data obtained by the imaging.

Here, the synchronous image sensor is an image sensor configured to perform imaging in synchronization with a vertical synchronization signal and output frame data that is image data in a frame format. The sensor section 21 can be regarded as asynchronous (an asynchronous image sensor) in contrast to the synchronous image sensor, since the sensor section 21 does not operate in synchronization with a vertical synchronization signal when outputting event data. In particular, the sensor section 21 can output event data with a temporal precision of 10⁻⁶ s.

Note that, the sensor section 21 may generate and output, other than event data, frame data, similarly to the synchronous image sensor. In addition, the sensor section 21 can output, together with event data, electrical signals of pixels in which events have occurred, as pixel signals that are pixel values of the pixels in frame data.

The logic section 22 controls the sensor section 21 as needed. Further, the logic section 22 performs various types of data processing, such as data processing of generating frame data on the basis of event data from the sensor section 21 and image processing on frame data from the sensor section 21 or frame data generated on the basis of the event data from the sensor section 21, and outputs data processing results obtained by performing the various types of data processing on the event data and the frame data. The logic section 22 may implement the functions of a control unit as described below.

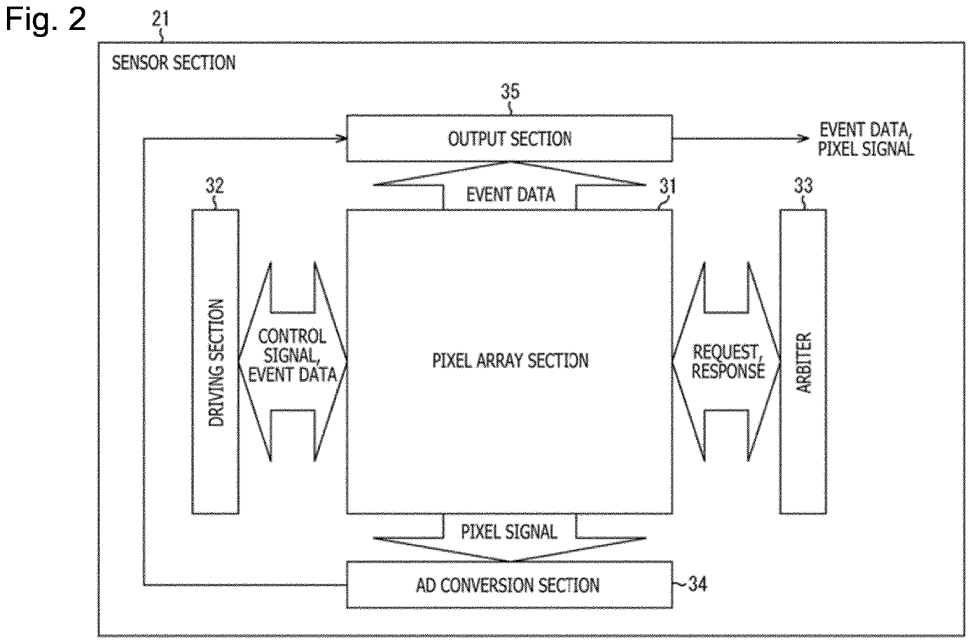

FIG. 2 is a block diagram illustrating a configuration example of the sensor section 21 of FIG. 1.

The sensor section 21 includes a pixel array section 31, a driving section 32, an arbiter 33, an AD (Analog to Digital) conversion section 34, and an output section 35.

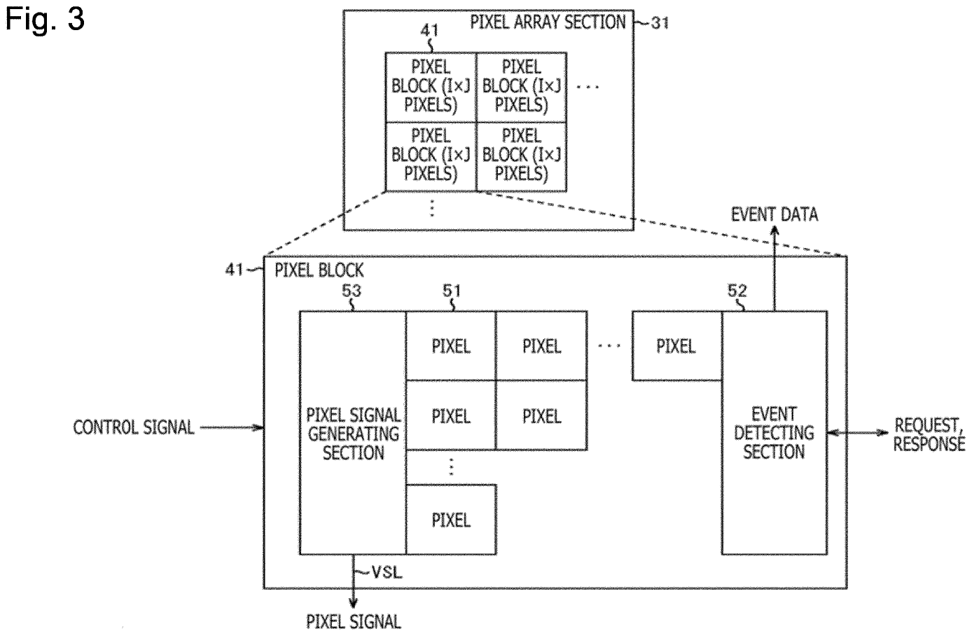

The pixel array section 31 includes a plurality of pixels 51 (FIG. 3) arrayed in a two-dimensional lattice pattern. The pixel array section 31 detects, in a case where a change larger than a predetermined threshold (including a change equal to or larger than the threshold as needed) has occurred in (a voltage corresponding to) a photocurrent that is an electrical signal generated by photoelectric conversion in the pixel 51, the change in the photocurrent as an event. In a case of detecting an event, the pixel array section 31 outputs, to the arbiter 33, a request for requesting the output of event data indicating the occurrence of the event. Then, in a case of receiving a response indicating event data output permission from the arbiter 33, the pixel array section 31 outputs the event data to the driving section 32 and the output section 35. In addition, the pixel array section 31 may output an electrical signal of the pixel 51 in which the event has been detected to the AD conversion section 34.

The driving section 32 supplies control signals to the pixel array section 31 to drive the pixel array section 31. For example, the driving section 32 drives the pixel 51 regarding which the pixel array section 31 has output event data, so that the pixel 51 in question supplies (outputs) a pixel signal to the AD conversion section 34.

The arbiter 33 arbitrates the requests for requesting the output of event data from the pixel array section 31, and returns responses indicating event data output permission or prohibition to the pixel array section 31.

The AD conversion section 34 includes, for example, a single-slope ADC (AD converter) (not illustrated) in each column of pixel blocks 41 (FIG. 3) described later, for example. The AD conversion section 34 performs, with the ADC in each column, AD conversion on pixel signals of the pixels 51 of the pixel blocks 41 in the column, and supplies the resultant to the output section 35. Note that, the AD conversion section 34 can perform CDS (Correlated Double Sampling) together with pixel signal AD conversion.

The output section 35 performs necessary processing on the pixel signals from the AD conversion section 34 and the event data from the pixel array section 31 and supplies the resultant to the logic section 22 (FIG. 1).

Here, a change in the photocurrent generated in the pixel 51 can be recognized as a change in the amount of light entering the pixel 51, so that it can also be said that an event is a change in light amount (a change in light amount larger than the threshold) in the pixel 51.

Event data indicating the occurrence of an event at least includes location information (coordinates or the like) indicating the location of a pixel block in which a change in light amount, which is the event, has occurred. Besides, the event data can also include the polarity (positive or negative) of the change in light amount.

With regard to the series of event data that is output from the pixel array section 31 at timings at which events have occurred, it can be said that, as long as the event data interval is the same as the event occurrence interval, the event data implicitly includes time point information indicating (relative) time points at which the events have occurred. However, for example, when the event data is stored in a memory and the event data interval is no longer the same as the event occurrence interval, the time point information implicitly included in the event data is lost. Thus, the output section 35 includes, in event data, time point information indicating (relative) time points at which events have occurred, such as timestamps, before the event data interval is changed from the event occurrence interval. The processing of including time point information in event data can be performed in any block other than the output section 35 as long as the processing is performed before time point information implicitly included in event data is lost.

FIG. 3 is a block diagram illustrating a configuration example of the pixel array section 31 of FIG. 2.

The pixel array section 31 includes the plurality of pixel blocks 41. The pixel block 41 includes the I×J pixels 51 that are one or more pixels arrayed in I rows and J columns (I and J are integers), an event detecting section 52, and a pixel signal generating section 53. The one or more pixels 51 in the pixel block 41 share the event detecting section 52 and the pixel signal generating section 53. Further, in each column of the pixel blocks 41, a VSL (Vertical Signal Line) for connecting the pixel blocks 41 to the ADC of the AD conversion section 34 is wired.

The pixel 51 receives light incident from an object and performs photoelectric conversion to generate a photocurrent serving as an electrical signal. The pixel 51 supplies the photocurrent to the event detecting section 52 under the control of the driving section 32.

The event detecting section 52 detects, as an event, a change larger than the predetermined threshold in photocurrent from each of the pixels 51, under the control of the driving section 32. In a case of detecting an event, the event detecting section 52 supplies, to the arbiter 33 (FIG. 2), a request for requesting the output of event data indicating the occurrence of the event. Then, when receiving a response indicating event data output permission to the request from the arbiter 33, the event detecting section 52 outputs the event data to the driving section 32 and the output section 35.

The pixel signal generating section 53 generates, in the case where the event detecting section 52 has detected an event, a voltage corresponding to a photocurrent from the pixel 51 as a pixel signal, and supplies the voltage to the AD conversion section 34 through the VSL, under the control of the driving section 32.

Here, detecting a change larger than the predetermined threshold in photocurrent as an event can also be recognized as detecting, as an event, absence of change larger than the predetermined threshold in photocurrent. The pixel signal generating section 53 can generate a pixel signal in the case where absence of change larger than the predetermined threshold in photocurrent has been detected as an event as well as in the case where a change larger than the predetermined threshold in photocurrent has been detected as an event.

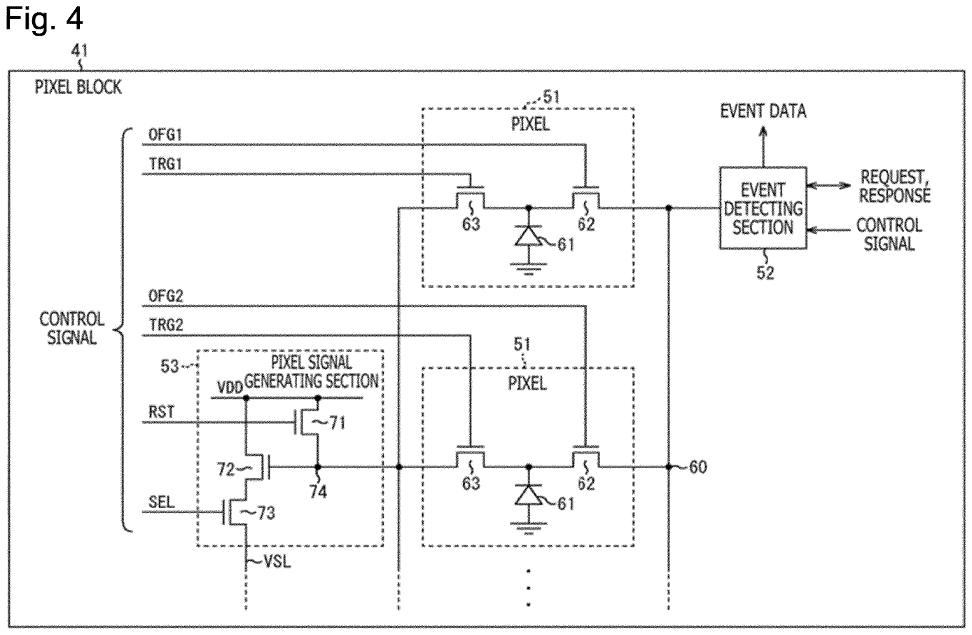

FIG. 4 is a circuit diagram illustrating a configuration example of the pixel block 41.

The pixel block 41 includes, as described with reference to FIG. 3, the pixels 51, the event detecting section 52, and the pixel signal generating section 53.

The pixel 51 includes a photoelectric conversion element 61 and transfer transistors 62 and 63.

The photoelectric conversion element 61 includes, for example, a PD (Photodiode). The photoelectric conversion element 61 receives incident light and performs photoelectric conversion to generate charges.

The transfer transistor 62 includes, for example, an N (Negative)-type MOS (Metal-Oxide-Semiconductor) FET (Field Effect Transistor). The transfer transistor 62 of the n-th pixel 51 of the I×J pixels 51 in the pixel block 41 is turned on or off in response to a control signal OFGn supplied from the driving section 32 (FIG. 2). When the transfer transistor 62 is turned on, charges generated in the photoelectric conversion element 61 are transferred (supplied) to the event detecting section 52, as a photocurrent.

The transfer transistor 63 includes, for example, an N-type MOSFET. The transfer transistor 63 of the n-th pixel 51 of the I×J pixels 51 in the pixel block 41 is turned on or off in response to a control signal TRGn supplied from the driving section 32. When the transfer transistor 63 is turned on, charges generated in the photoelectric conversion element 61 are transferred to an FD 74 of the pixel signal generating section 53.

The I×J pixels 51 in the pixel block 41 are connected to the event detecting section 52 of the pixel block 41 through nodes 60. Thus, photocurrents generated in (the photoelectric conversion elements 61 of) the pixels 51 are supplied to the event detecting section 52 through the nodes 60. As a result, the event detecting section 52 receives the sum of photocurrents from all the pixels 51 in the pixel block 41. Thus, the event detecting section 52 detects, as an event, a change in sum of photocurrents supplied from the I×J pixels 51 in the pixel block 41.

The pixel signal generating section 53 includes a reset transistor 71, an amplification transistor 72, a selection transistor 73, and the FD (Floating Diffusion) 74.

The reset transistor 71, the amplification transistor 72, and the selection transistor 73 include, for example, N-type MOSFETs.

The reset transistor 71 is turned on or off in response to a control signal RST supplied from the driving section 32 (FIG. 2). When the reset transistor 71 is turned on, the FD 74 is connected to a power supply VDD, and charges accumulated in the FD 74 are thus discharged to the power supply VDD. With this, the FD 74 is reset.

The amplification transistor 72 has a gate connected to the FD 74, a drain connected to the power supply VDD, and a source connected to the VSL through the selection transistor 73. The amplification transistor 72 is a source follower and outputs a voltage (electrical signal) corresponding to the voltage of the FD 74 supplied to the gate to the VSL through the selection transistor 73.

The selection transistor 73 is turned on or off in response to a control signal SEL supplied from the driving section 32. When the selection transistor 73 is turned on, a voltage corresponding to the voltage of the FD 74 from the amplification transistor 72 is output to the VSL.

The FD 74 accumulates charges transferred from the photoelectric conversion elements 61 of the pixels 51 through the transfer transistors 63, and converts the charges to voltages.

With regard to the pixels 51 and the pixel signal generating section 53, which are configured as described above, the driving section 32 turns on the transfer transistors 62 with control signals OFGn, so that the transfer transistors 62 supply, to the event detecting section 52, photocurrents based on charges generated in the photoelectric conversion elements 61 of the pixels 51. With this, the event detecting section 52 receives a current that is the sum of the photocurrents from all the pixels 51 in the pixel block 41, which might also be only a single pixel.

When the event detecting section 52 detects, as an event, a change in photocurrent (sum of photocurrents) in the pixel block 41, the driving section 32 turns off the transfer transistors 62 of all the pixels 51 in the pixel block 41, to thereby stop the supply of the photocurrents to the event detecting section 52. Then, the driving section 32 sequentially turns on, with the control signals TRGn, the transfer transistors 63 of the pixels 51 in the pixel block 41 in which the event has been detected, so that the transfer transistors 63 transfers charges generated in the photoelectric conversion elements 61 to the FD 74. The FD 74 accumulates the charges transferred from (the photoelectric conversion elements 61 of) the pixels 51. Voltages corresponding to the charges accumulated in the FD 74 are output to the VSL, as pixel signals of the pixels 51, through the amplification transistor 72 and the selection transistor 73.

As described above, in the sensor section 21 (FIG. 2), only pixel signals of the pixels 51 in the pixel block 41 in which an event has been detected are sequentially output to the VSL. The pixel signals output to the VSL are supplied to the AD conversion section 34 to be subjected to AD conversion.

Here, in the pixels 51 in the pixel block 41, the transfer transistors 63 can be turned on not sequentially but simultaneously. In this case, the sum of pixel signals of all the pixels 51 in the pixel block 41 can be output.

In the pixel array section 31 of FIG. 3, the pixel block 41 includes one or more pixels 51, and the one or more pixels 51 share the event detecting section 52 and the pixel signal generating section 53. Thus, in the case where the pixel block 41 includes a plurality of pixels 51, the numbers of the event detecting sections 52 and the pixel signal generating sections 53 can be reduced as compared to a case where the event detecting section 52 and the pixel signal generating section 53 are provided for each of the pixels 51, with the result that the scale of the pixel array section 31 can be reduced.

Note that, in the case where the pixel block 41 includes a plurality of pixels 51, the event detecting section 52 can be provided for each of the pixels 51. In the case where the plurality of pixels 51 in the pixel block 41 share the event detecting section 52, events are detected in units of the pixel blocks 41. In the case where the event detecting section 52 is provided for each of the pixels 51, however, events can be detected in units of the pixels 51.

Yet, even in the case where the plurality of pixels 51 in the pixel block 41 share the single event detecting section 52, events can be detected in units of the pixels 51 when the transfer transistors 62 of the plurality of pixels 51 are temporarily turned on in a time-division manner.

Further, in a case where there is no need to output pixel signals, the pixel block 41 can be formed without the pixel signal generating section 53. In the case where the pixel block 41 is formed without the pixel signal generating section 53, the sensor section 21 can be formed without the AD conversion section 34 and the transfer transistors 63. In this case, the scale of the sensor section 21 can be reduced. The sensor will then output the address of the pixel (block) in which the event occurred, if necessary with a time stamp.

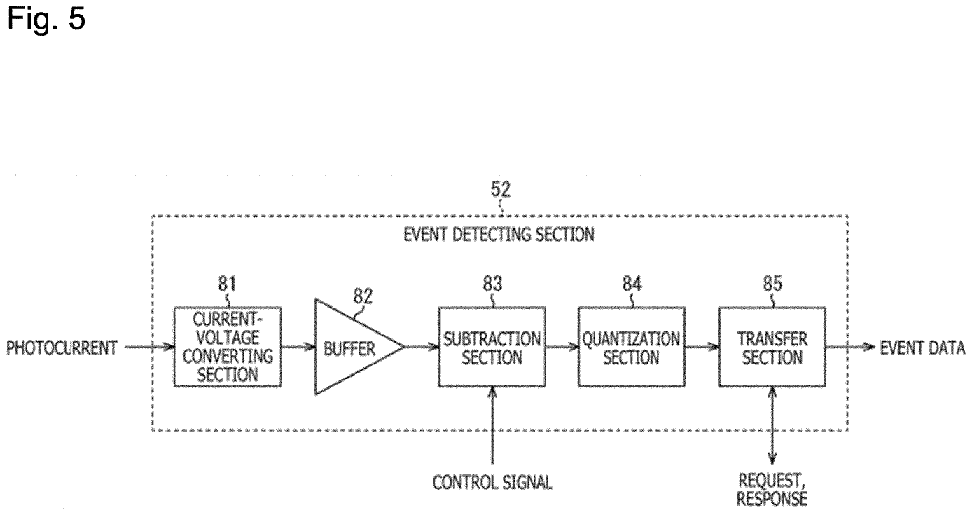

FIG. 5 is a block diagram illustrating a configuration example of the event detecting section 52 of FIG. 3.

The event detecting section 52 includes a current-voltage converting section 81, a buffer 82, a subtraction section 83, a quantization section 84, and a transfer section 85.

The current-voltage converting section 81 converts (a sum of) photocurrents from the pixels 51 to voltages corresponding to the logarithms of the photocurrents (hereinafter also referred to as a “photovoltage”) and supplies the voltages to the buffer 82.

The buffer 82 buffers photovoltages from the current-voltage converting section 81 and supplies the resultant to the subtraction section 83.

The subtraction section 83 calculates, at a timing instructed by a row driving signal that is a control signal from the driving section 32, a difference between the current photovoltage and a photovoltage at a timing slightly shifted from the current time, and supplies a difference signal corresponding to the difference to the quantization section 84.

The quantization section 84 quantizes difference signals from the subtraction section 83 to digital signals and supplies the quantized values of the difference signals to the transfer section 85 as event data.

The transfer section 85 transfers (outputs), on the basis of event data from the quantization section 84, the event data to the output section 35. That is, the transfer section 85 supplies a request for requesting the output of the event data to the arbiter 33. Then, when receiving a response indicating event data output permission to the request from the arbiter 33, the transfer section 85 outputs the event data to the output section 35.

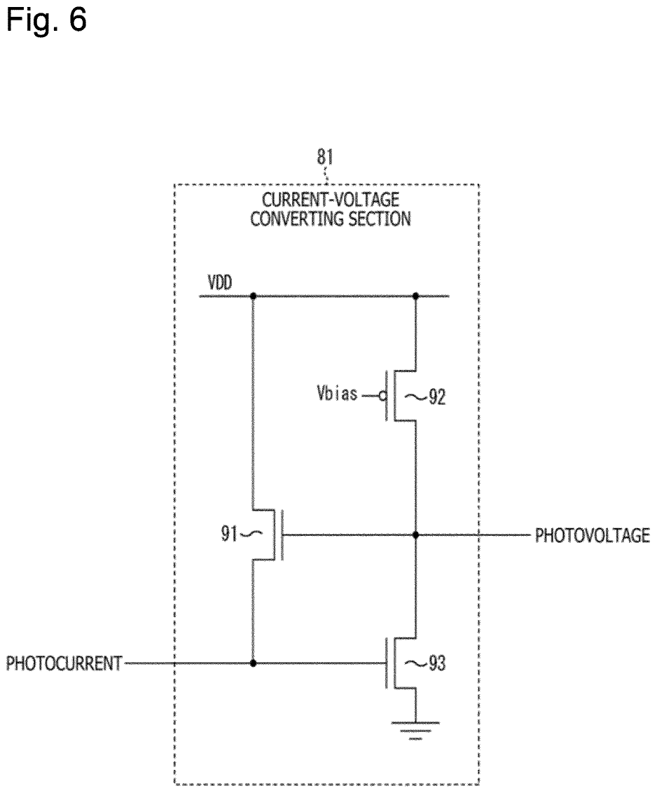

FIG. 6 is a circuit diagram illustrating a configuration example of the current-voltage converting section 81 of FIG. 5.

The current-voltage converting section 81 includes transistors 91 to 93. As the transistors 91 and 93, for example, N-type MOSFETs can be employed. As the transistor 92, for example, a P-type MOSFET can be employed.

The transistor 91 has a source connected to the gate of the transistor 93, and a photocurrent is supplied from the pixel 51 to the connecting point between the source of the transistor 91 and the gate of the transistor 93. The transistor 91 has a drain connected to the power supply VDD and a gate connected to the drain of the transistor 93.

The transistor 92 has a source connected to the power supply VDD and a drain connected to the connecting point between the gate of the transistor 91 and the drain of the transistor 93. A predetermined bias voltage Vbias is applied to the gate of the transistor 92. With the bias voltage Vbias, the transistor 92 is turned on or off, and the operation of the current-voltage converting section 81 is turned on or off depending on whether the transistor 92 is turned on or off.

The source of the transistor 93 is grounded.

In the current-voltage converting section 81, the transistor 91 has the drain connected on the power supply VDD side. The source of the transistor 91 is connected to the pixels 51 (FIG. 4), so that photocurrents based on charges generated in the photoelectric conversion elements 61 of the pixels 51 flow through the transistor 91 (from the drain to the source). The transistor 91 operates in a subthreshold region, and at the gate of the transistor 91, photovoltages corresponding to the logarithms of the photocurrents flowing through the transistor 91 are generated. As described above, in the current-voltage converting section 81, the transistor 91 converts photocurrents from the pixels 51 to photovoltages corresponding to the logarithms of the photocurrents.

In the current-voltage converting section 81, the transistor 91 has the gate connected to the connecting point between the drain of the transistor 92 and the drain of the transistor 93, and the photovoltages are output from the connecting point in question.

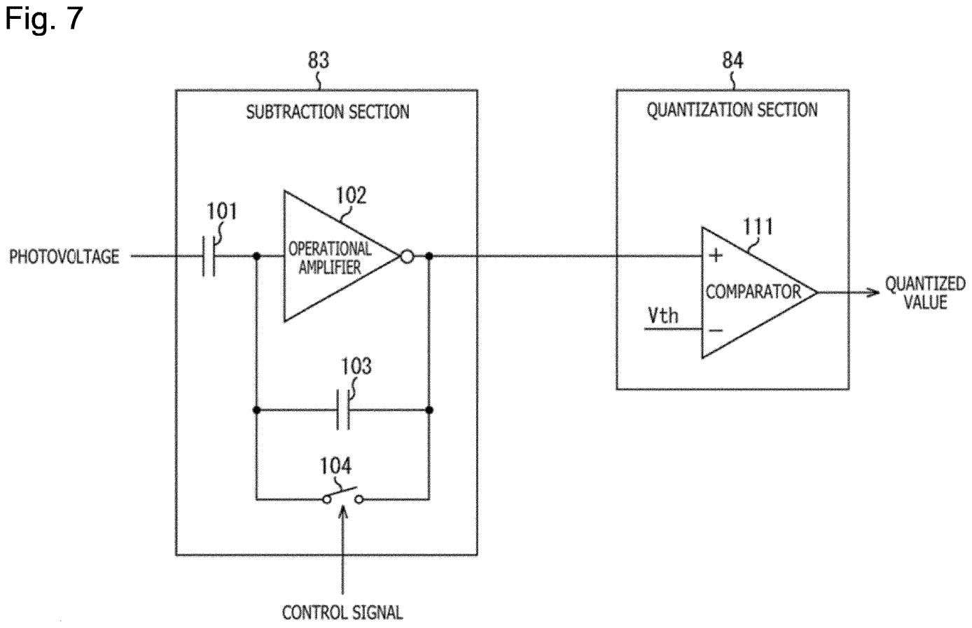

FIG. 7 is a circuit diagram illustrating configuration examples of the subtraction section 83 and the quantization section 84 of FIG. 5.

The subtraction section 83 includes a capacitor 101, an operational amplifier 102, a capacitor 103, and a switch 104. The quantization section 84 includes a comparator 111.

The capacitor 101 has one end connected to the output terminal of the buffer 82 (FIG. 5) and the other end connected to the input terminal (inverting input terminal) of the operational amplifier 102. Thus, photovoltages are input to the input terminal of the operational amplifier 102 through the capacitor 101.

The operational amplifier 102 has an output terminal connected to the non-inverting input terminal (+) of the comparator 111.

The capacitor 103 has one end connected to the input terminal of the operational amplifier 102 and the other end connected to the output terminal of the operational amplifier 102.

The switch 104 is connected to the capacitor 103 to switch the connections between the ends of the capacitor 103.

The switch 104 is turned on or off in response to a row driving signal that is a control signal from the driving section 32, to thereby switch the connections between the ends of the capacitor 103.

A photovoltage on the buffer 82 (FIG. 5) side of the capacitor 101 when the switch 104 is on is denoted by Vinit, and the capacitance (electrostatic capacitance) of the capacitor 101 is denoted by C1. The input terminal of the operational amplifier 102 serves as a virtual ground terminal, and a charge Qinit that is accumulated in the capacitor 101 in the case where the switch 104 is on is expressed by Expression (1).

$$Qinit = C 1 \times V init \qquad ( 1 )$$

Further, in the case where the switch 104 is on, the connection between the ends of the capacitor 103 is cut (short-circuited), so that no charge is accumulated in the capacitor 103.

When a photovoltage on the buffer 82 (FIG. 5) side of the capacitor 101 in the case where the switch 104 has thereafter been turned off is denoted by Vafter, a charge Qafter that is accumulated in the capacitor 101 in the case where the switch 104 is off is expressed by Expression (2).

$$Qafter = C 1 \times V after \qquad ( 2 )$$

When the capacitance of the capacitor 103 is denoted by C2 and the output voltage of the operational amplifier 102 is denoted by Vout, a charge Q2 that is accumulated in the capacitor 103 is expressed by Expression (3).

$$Q 2 = - C 2 \times V out \qquad ( 3 )$$

Since the total amount of charges in the capacitors 101 and 103 does not change before and after the switch 104 is turned off, Expression (4) is established.

$$Qinit = Qafter + Q 2 \qquad ( 4 )$$

When Expression (1) to Expression (3) are substituted for Expression (4), Expression (5) is obtained.

$$V out = - ( C 1 / C 2 ) \times ( V after - V init ) \qquad ( 5 )$$

With Expression (5), the subtraction section 83 subtracts the photovoltage Vinit from the photovoltage Vafter, that is, calculates the difference signal (Vout) corresponding to a difference Vafter−Vinit between the photovoltages Vafter and Vinit. With Expression (5), the subtraction gain of the subtraction section 83 is C1/C2. Since the maximum gain is normally desired, C1 is preferably set to a large value and C2 is preferably set to a small value. Meanwhile, when C2 is too small, kTC noise increases, resulting in a risk of deteriorated noise characteristics. Thus, the capacitance C2 can only be reduced in a range that achieves acceptable noise. Further, since the pixel blocks 41 each have installed therein the event detecting section 52 including the subtraction section 83, the capacitances C1 and C2 have space constraints. In consideration of these matters, the values of the capacitances C1 and C2 are determined.

The comparator 111 compares a difference signal from the subtraction section 83 with a predetermined threshold (voltage) Vth (>0) applied to the inverting input terminal (−), thereby quantizing the difference signal. The comparator 111 outputs the quantized value obtained by the quantization to the transfer section 85 as event data.

For example, in a case where a difference signal is larger than the threshold Vth, the comparator 111 outputs an H (High) level indicating 1, as event data indicating the occurrence of an event. In a case where a difference signal is not larger than the threshold Vth, the comparator 111 outputs an L (Low) level indicating 0, as event data indicating that no event has occurred.

The transfer section 85 supplies a request to the arbiter 33 in a case where it is confirmed on the basis of event data from the quantization section 84 that a change in light amount that is an event has occurred, that is, in the case where the difference signal (Vout) is larger than the threshold Vth. When receiving a response indicating event data output permission, the transfer section 85 outputs the event data indicating the occurrence of the event (for example, H level) to the output section 35.

The output section 35 includes, in event data from the transfer section 85, location/address information regarding (the pixel block 41 including) the pixel 51 in which an event indicated by the event data has occurred and time point information indicating a time point at which the event has occurred, and further, as needed, the polarity of a change in light amount that is the event, i.e. whether the intensity did increase or decrease. The output section 35 outputs the event data.

As the data format of event data including location information regarding the pixel 51 in which an event has occurred, time point information indicating a time point at which the event has occurred, and the polarity of a change in light amount that is the event, for example, the data format called “AER (Address Event Representation)” can be employed.

Note that, a gain A of the entire event detecting section 52 is expressed by the following expression where the gain of the current-voltage converting section 81 is denoted by CG_{log} and the gain of the buffer 82 is 1.

$$A = {CG}_{log} C 1 / C 2 ( \sum {i}_{photo} \_n ) \qquad ( 6 )$$

Here, iₚₕₒₜₒ_n denotes a photocurrent of the n-th pixel 51 of the I×J pixels 51 in the pixel block 41. In Expression (6), 2 denotes the summation of n that takes integers ranging from 1 to I×J.

Note that, the pixel 51 can receive any light as incident light with an optical filter through which predetermined light passes, such as a color filter. For example, in a case where the pixel 51 receives visible light as incident light, event data indicates the occurrence of changes in pixel value in images including visible objects. Further, for example, in a case where the pixel 51 receives, as incident light, infrared light, millimeter waves, or the like for ranging, event data indicates the occurrence of changes in distances to objects. In addition, for example, in a case where the pixel 51 receives infrared light for temperature measurement, as incident light, event data indicates the occurrence of changes in temperature of objects. In the present embodiment, the pixel 51 is assumed to receive visible light as incident light.

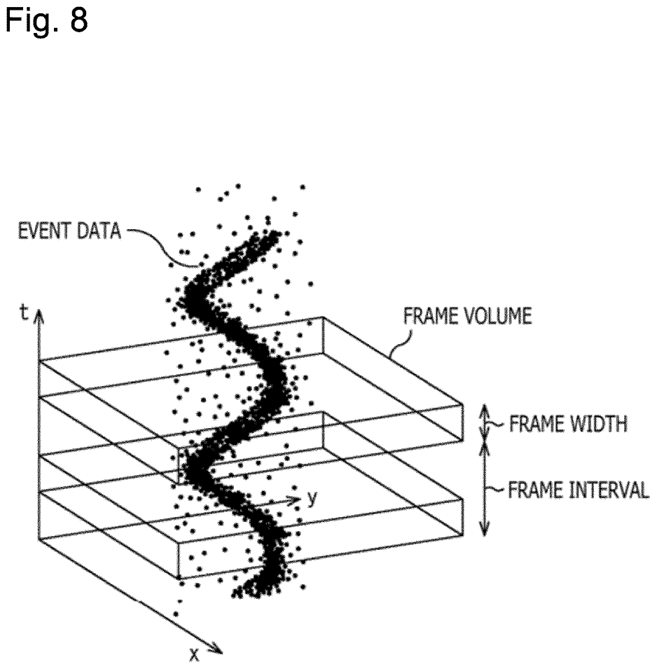

FIG. 8 is a diagram illustrating an example of a frame data generation method based on event data.

The logic section 22 sets a frame interval and a frame width on the basis of an externally input command, for example. Here, the frame interval represents the interval of frames of frame data that is generated on the basis of event data. The frame width represents the time width of event data that is used for generating frame data on a single frame. A frame interval and a frame width that are set by the logic section 22 are also referred to as a “set frame interval” and a “set frame width,” respectively.

The logic section 22 generates, on the basis of the set frame interval, the set frame width, and event data from the sensor section 21, frame data that is image data in a frame format, to thereby convert the event data to the frame data.

That is, the logic section 22 generates, in each set frame interval, frame data on the basis of event data in the set frame width from the beginning of the set frame interval.

Here, it is assumed that event data includes time point information tᵢ indicating a time point at which an event has occurred (hereinafter also referred to as an “event time point”) and coordinates (x, y) serving as location information regarding (the pixel block 41 including) the pixel 51 in which the event has occurred (hereinafter also referred to as an “event location”).

In FIG. 8, in a three-dimensional space (time and space) with the x axis, the y axis, and the time axis t, points representing event data are plotted on the basis of the event time point t and the event location (coordinates) (x, y) included in the event data.

That is, when a location (x, y, t) on the three-dimensional space indicated by the event time point t and the event location (x, y) included in event data is regarded as the space-time location of an event, in FIG. 8, the points representing the event data are plotted on the space-time locations (x, y, t) of the events.

The logic section 22 starts to generate frame data on the basis of event data by using, as a generation start time point at which frame data generation starts, a predetermined time point, for example, a time point at which frame data generation is externally instructed or a time point at which the sensor device 10 is powered on.

Here, cuboids each having the set frame width in the direction of the time axis t in the set frame intervals, which appear from the generation start time point, are referred to as a “frame volume.” The size of the frame volume in the x-axis direction or the y-axis direction is equal to the number of the pixel blocks 41 or the pixels 51 in the x-axis direction or the y-axis direction, for example.

The logic section 22 generates, in each set frame interval, frame data on a single frame on the basis of event data in the frame volume having the set frame width from the beginning of the set frame interval.

Frame data can be generated by, for example, setting white to a pixel (pixel value) in a frame at the event location (x, y) included in event data and setting a predetermined color such as gray to pixels at other locations in the frame.

Besides, in a case where event data includes the polarity of a change in light amount that is an event, frame data can be generated in consideration of the polarity included in the event data. For example, white can be set to pixels in the case a positive polarity, while black can be set to pixels in the case of a negative polarity.

In addition, in the case where pixel signals of the pixels 51 are also output when event data is output as described with reference to FIG. 3 and FIG. 4, frame data can be generated on the basis of the event data by using the pixel signals of the pixels 51. That is, frame data can be generated by setting, in a frame, a pixel at the event location (x, y) (in a block corresponding to the pixel block 41) included in event data to a pixel signal of the pixel 51 at the location (x, y) and setting a predetermined color such as gray to pixels at other locations.

Note that, in the frame volume, there are a plurality of pieces of event data that are different in the event time point t but the same in the event location (x, y) in some cases. In this case, for example, event data at the latest or oldest event time point t can be prioritized. Further, in the case where event data includes polarities, the polarities of a plurality of pieces of event data that are different in the event time point t but the same in the event location (x, y) can be added together, and a pixel value based on the added value obtained by the addition can be set to a pixel at the event location (x, y).

Here, in a case where the frame width and the frame interval are the same, the frame volumes are adjacent to each other without any gap. Further, in a case where the frame interval is larger than the frame width, the frame volumes are arranged with gaps. In a case where the frame width is larger than the frame interval, the frame volumes are arranged to be partly overlapped with each other.

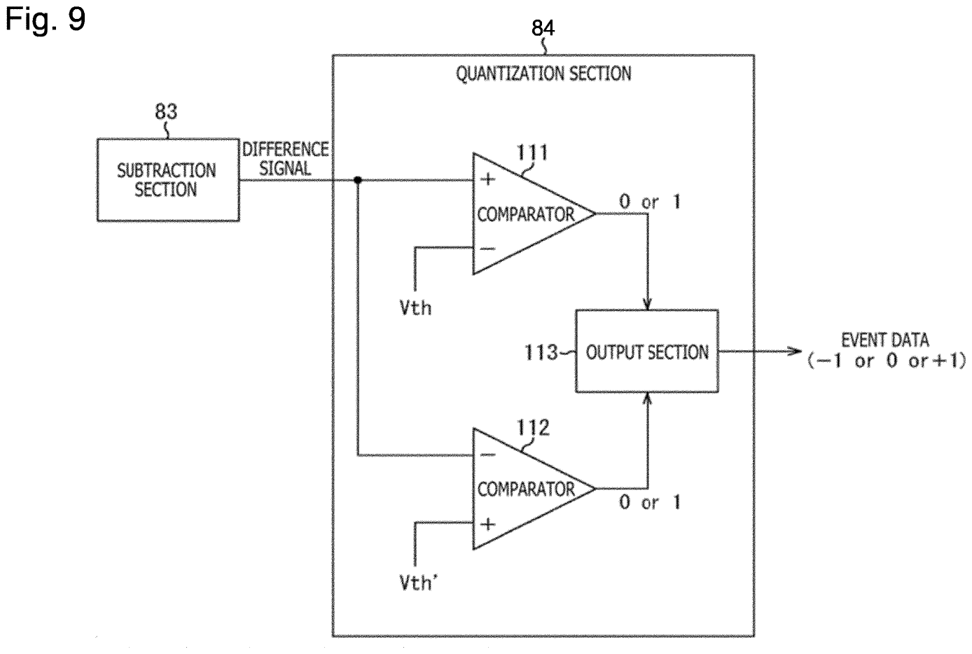

FIG. 9 is a block diagram illustrating another configuration example of the quantization section 84 of FIG. 5.

Note that, in FIG. 9, parts corresponding to those in the case of FIG. 7 are denoted by the same reference signs, and the description thereof is omitted as appropriate below.

In FIG. 9, the quantization section 84 includes comparators 111 and 112 and an output section 113.

Thus, the quantization section 84 of FIG. 9 is similar to the case of FIG. 7 in including the comparator 111. However, the quantization section 84 of FIG. 9 is different from the case of FIG. 7 in newly including the comparator 112 and the output section 113.

The event detecting section 52 (FIG. 5) including the quantization section 84 of FIG. 9 detects, in addition to events, the polarities of changes in light amount that are events.

In the quantization section 84 of FIG. 9, the comparator 111 outputs, in the case where a difference signal is larger than the threshold Vth, the H level indicating 1, as event data indicating the occurrence of an event having the positive polarity. The comparator 111 outputs, in the case where a difference signal is not larger than the threshold Vth, the L level indicating 0, as event data indicating that no event having the positive polarity has occurred.

Further, in the quantization section 84 of FIG. 9, a threshold Vth′ (<Vth) is supplied to the non-inverting input terminal (+) of the comparator 112, and difference signals are supplied to the inverting input terminal (−) of the comparator 112 from the subtraction section 83. Here, for the sake of simple description, it is assumed that the threshold Vth′ is equal to −Vth, for example, which needs however not to be the case.

The comparator 112 compares a difference signal from the subtraction section 83 with the threshold Vth′ applied to the inverting input terminal (−), thereby quantizing the difference signal. The comparator 112 outputs, as event data, the quantized value obtained by the quantization.

For example, in a case where a difference signal is smaller than the threshold Vth′ (the absolute value of the difference signal having a negative value is larger than the threshold Vth), the comparator 112 outputs the H level indicating 1, as event data indicating the occurrence of an event having the negative polarity. Further, in a case where a difference signal is not smaller than the threshold Vth′ (the absolute value of the difference signal having a negative value is not larger than the threshold Vth), the comparator 112 outputs the L level indicating 0, as event data indicating that no event having the negative polarity has occurred.

The output section 113 outputs, on the basis of event data output from the comparators 111 and 112, event data indicating the occurrence of an event having the positive polarity, event data indicating the occurrence of an event having the negative polarity, or event data indicating that no event has occurred to the transfer section 85.

For example, the output section 113 outputs, in a case where event data from the comparator 111 is the H level indicating 1, +V volts indicating +1, as event data indicating the occurrence of an event having the positive polarity, to the transfer section 85. Further, the output section 113 outputs, in a case where event data from the comparator 112 is the H level indicating 1, −V volts indicating −1, as event data indicating the occurrence of an event having the negative polarity, to the transfer section 85. In addition, the output section 113 outputs, in a case where each event data from the comparators 111 and 112 is the L level indicating 0, 0 volts (GND level) indicating 0, as event data indicating that no event has occurred, to the transfer section 85.

The transfer section 85 supplies a request to the arbiter 33 in the case where it is confirmed on the basis of event data from the output section 113 of the quantization section 84 that a change in light amount that is an event having the positive polarity or the negative polarity has occurred. After receiving a response indicating event data output permission, the transfer section 85 outputs event data indicating the occurrence of the event having the positive polarity or the negative polarity (+V volts indicating 1 or −V volts indicating −1) to the output section 35.

Preferably, the quantization section 84 has a configuration as illustrated in FIG. 9.

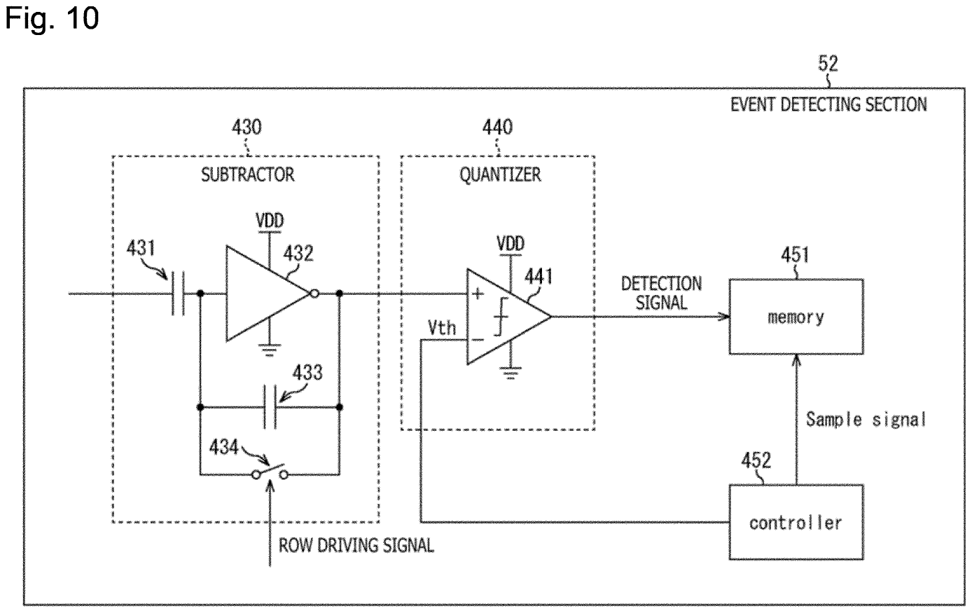

FIG. 10 is a diagram illustrating another configuration example of the event detecting section 52.

In FIG. 10, the event detecting section 52 includes a subtractor 430, a quantizer 440, a memory 451, and a controller 452. The subtractor 430 and the quantizer 440 correspond to the subtraction section 83 and the quantization section 84, respectively.

Note that, in FIG. 10, the event detecting section 52 further includes blocks corresponding to the current-voltage converting section 81 and the buffer 82, but the illustrations of the blocks are omitted in FIG. 10.

The subtractor 430 includes a capacitor 431, an operational amplifier 432, a capacitor 433, and a switch 434. The capacitor 431, the operational amplifier 432, the capacitor 433, and the switch 434 correspond to the capacitor 101, the operational amplifier 102, the capacitor 103, and the switch 104, respectively.

The quantizer 440 includes a comparator 441. The comparator 441 corresponds to the comparator 111.

The comparator 441 compares a voltage signal (difference signal) from the subtractor 430 with the predetermined threshold voltage Vth applied to the inverting input terminal (−). The comparator 441 outputs a signal indicating the comparison result, as a detection signal (quantized value).

The voltage signal from the subtractor 430 may be input to the input terminal (−) of the comparator 441, and the predetermined threshold voltage Vth may be input to the input terminal (+) of the comparator 441.

The controller 452 supplies the predetermined threshold voltage Vth applied to the inverting input terminal (−) of the comparator 441. The threshold voltage Vth which is supplied may be changed in a time-division manner. For example, the controller 452 supplies a threshold voltage Vth1 corresponding to ON events (for example, positive changes in photocurrent) and a threshold voltage Vth2 corresponding to OFF events (for example, negative changes in photocurrent) at different timings to allow the single comparator to detect a plurality of types of address events (events).

The memory 451 accumulates output from the comparator 441 on the basis of Sample signals supplied from the controller 452. The memory 451 may be a sampling circuit, such as a switch, plastic, or capacitor, or a digital memory circuit, such as a latch or flip-flop. For example, the memory 451 may hold, in a period in which the threshold voltage Vth2 corresponding to OFF events is supplied to the inverting input terminal (−) of the comparator 441, the result of comparison by the comparator 441 using the threshold voltage Vth1 corresponding to ON events. Note that, the memory 451 may be omitted, may be provided inside the pixel (pixel block 41), or may be provided outside the pixel.

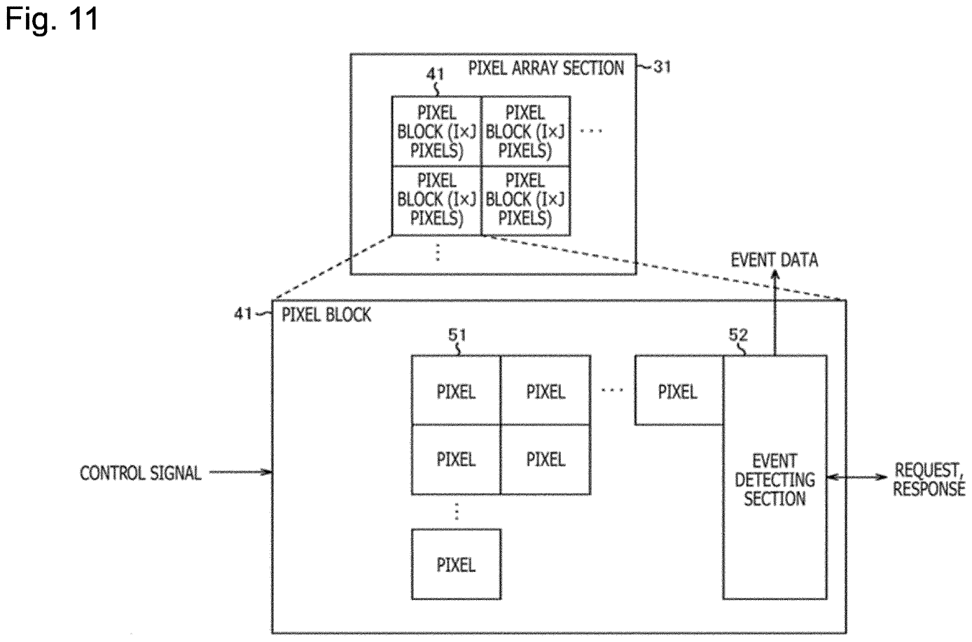

FIG. 11 is a block diagram illustrating another configuration example of the pixel array section 31 of FIG. 2.

Note that, in FIG. 11, parts corresponding to those in the case of FIG. 3 are denoted by the same reference signs, and the description thereof is omitted as appropriate below.

In FIG. 11, the pixel array section 31 includes the plurality of pixel blocks 41. The pixel block 41 includes the I×J pixels 51 that are one or more pixels and the event detecting section 52.

Thus, the pixel array section 31 of FIG. 11 is similar to the case of FIG. 3 in that the pixel array section 31 includes the plurality of pixel blocks 41 and that the pixel block 41 includes one or more pixels 51 and the event detecting section 52. However, the pixel array section 31 of FIG. 11 is different from the case of FIG. 3 in that the pixel block 41 does not include the pixel signal generating section 53.

As described above, in the pixel array section 31 of FIG. 11, the pixel block 41 does not include the pixel signal generating section 53, so that the sensor section 21 (FIG. 2) can be formed without the AD conversion section 34.

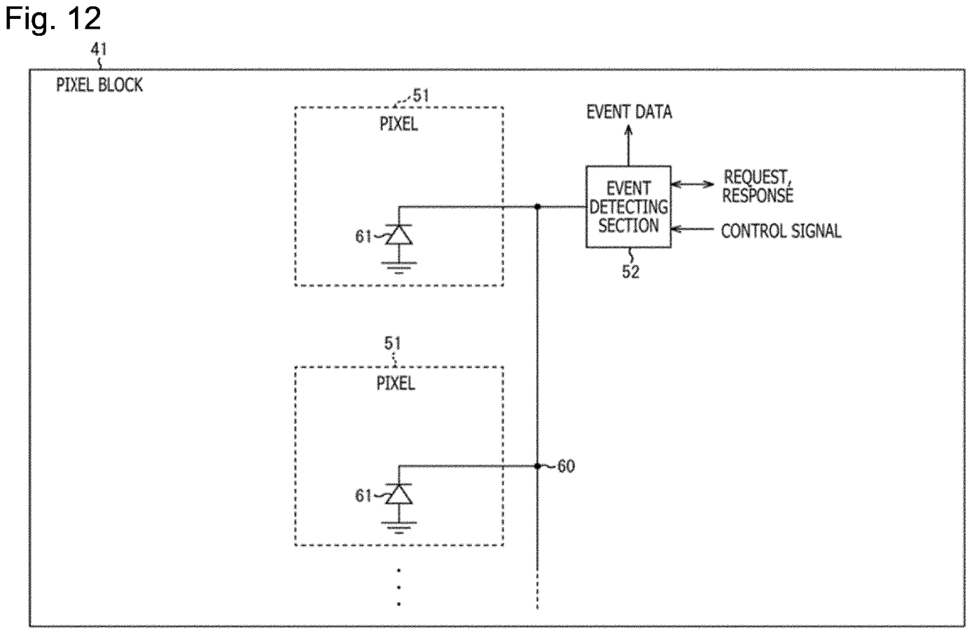

FIG. 12 is a circuit diagram illustrating a configuration example of the pixel block 41 of FIG. 11.

As described with reference to FIG. 11, the pixel block 41 includes the pixels 51 and the event detecting section 52, but does not include the pixel signal generating section 53.

In this case, the pixel 51 can only include the photoelectric conversion element 61 without the transfer transistors 62 and 63.

Note that, in the case where the pixel 51 has the configuration illustrated in FIG. 12, the event detecting section 52 can output a voltage corresponding to a photocurrent from the pixel 51, as a pixel signal.

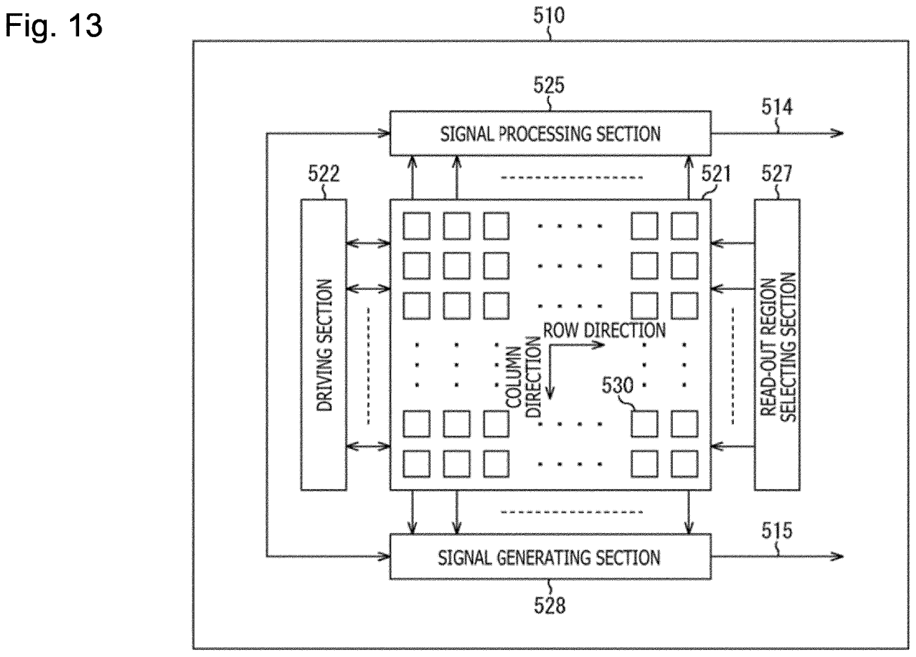

FIG. 13 is a block diagram illustrating a configuration example of a scan type imaging device which may be used as an EVS.

As illustrated in FIG. 13, an imaging device 510 includes a pixel array section 521, a driving section 522, a signal processing section 525, a read-out region selecting section 527, and an optional signal generating section 528.

The pixel array section 521 includes a plurality of pixels 530. The plurality of pixels 530 each output an output signal in response to a selection signal from the read-out region selecting section 527. The plurality of pixels 530 can each include an in-pixel quantizer as illustrated in FIG. 10, for example. The plurality of pixels 530 outputs output signals corresponding to the amounts of change in light intensity. The plurality of pixels 530 may be two-dimensionally disposed in a matrix as illustrated in FIG. 13.

The driving section 522 drives the plurality of pixels 530, so that the pixels 530 output pixel signals generated in the pixels 530 to the signal processing section 525 through an output line 514. Note that, the driving section 522 and the signal processing section 525 are circuit sections for acquiring grayscale information.

The read-out region selecting section 527 selects some of the plurality of pixels 530 included in the pixel array section 521. For example, the read-out region selecting section 527 selects one or a plurality of rows included in the two-dimensional matrix structure corresponding to the pixel array section 521. The read-out region selecting section 527 sequentially selects one or a plurality of rows on the basis of a cycle set in advance, e.g. based on a rolling shutter. Further, the read-out region selecting section 527 may determine a selection region on the basis of requests from the pixels 530 in the pixel array section 521.

The optional signal generating section 528 may generate, on the basis of output signals of the pixels 530 selected by the read-out region selecting section 527, event signals corresponding to active pixels in which events have been detected of the selected pixels 530. The events mean an event that the intensity of light changes. The active pixels mean the pixel 530 in which the amount of change in light intensity corresponding to an output signal exceeds or falls below a threshold set in advance. For example, the signal generating section 528 compares output signals from the pixels 530 with a reference signal, and detects, as an active pixel, a pixel that outputs an output signal larger or smaller than the reference signal. The signal generating section 528 generates an event signal (event data) corresponding to the active pixel.

The signal generating section 528 can include, for example, a column selecting circuit configured to arbitrate signals input to the signal generating section 528. Further, the signal generating section 528 can output not only information regarding active pixels in which events have been detected, but also information regarding non-active pixels in which no event has been detected.

The signal generating section 528 outputs, through an output line 515, address information and timestamp information (for example, (X, Y, T)) regarding the active pixels in which the events have been detected. However, the data that is output from the signal generating section 528 may not only be the address information and the timestamp information, but also information in a frame format (for example, (0, 0, 1, 0, . . . )).

In the following description reference will mainly be made to sensor devices of the EVS type as described above in order to ease the description and to cover an important application example. However, the principles explained below apply just as well to general sensor devices that are capable to make measurements based on measurement parameters.

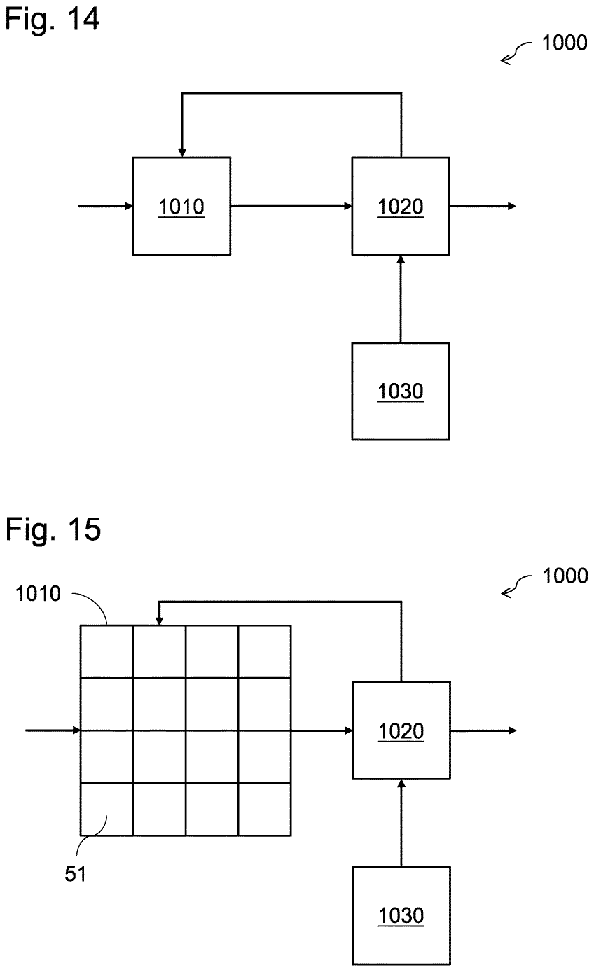

FIG. 14 shows a schematic illustration of a sensor device 1000 that comprises a measurement unit 1010, a control unit 1020, and a storage unit 1030.

The measurement unit 1010 is used to make measurements on the environment based on measurement parameters, wherein measuring the same quantity twice with different parameters yields different measurement results. The measurement unit 1010 may be a pixel array of an event-based vision sensor as described above with reference to FIGS. 1 to 13. However, the measurement unit 1010 may in principle also be any other device that is capable to perform measurements. For example, the measurement unit 1010 may constitute a silicon cochlea or a single photon avalanche diode, SPAD.

The measurement parameters determine how the measurement is executed, i.e. which measurement values will be generated by the measurement unit 1010. When the measurement parameters are sufficiently changed, this will result in a change of the obtained measurement results, even if the remaining measurement setup has not changed. In particular, measurement parameters may be voltage or currents applied to the measurement unit 1010 that affect, e.g. the sensitivity of the measurement unit 1010, the bandwidth and/or the temporal resolution of the measurements. Setting the measurement parameters to specific values will restrict the measurement to corresponding, specific measurement conditions, while changing the measurement parameters will also change the measurement conditions. Thus, it might only be possible to obtain a full measurement when applying different measurement parameters. Specific examples of measurement parameters for EVS sensors will be discussed below.

The control unit 1020 is configured to vary the measurement parameters over time according to a predetermined variation pattern while the measurement unit 1010 makes measurements. The control unit 1020 may be any kind of processing unit, circuitry, hardware, software or a mixture thereof that is capable to carry out the functions of the control unit 1020 discussed herein.

For example, the control unit 1020 refers to a pre-stored variation pattern of the measurement parameters (e.g. stored in the storage unit 1030) and changes the measurement parameters that are applied to the measurement unit 1010 accordingly. In particular, voltages and/or currents used for operating the measurement unit 1010 may be varied. Also, measurement timing and/or the run-time of measurements may be varied. In this manner, the measurement unit 1010 is able to gather measurement results not only for a single measurement condition, but for all measurement conditions covered by the variation of the measurement parameters. This increases the information obtainable by the measurement.

The storage unit 1030 is configured to store a plurality of temporal series of measurement results, wherein different temporal series represent measurements made with the predetermined variation pattern of measurement parameters in different measurement situations.

Here, the term “measurement situation” is used to denote any setting to be measured that can be distinguished from another setting. Thus, it is in principle possible to discern based on measurement results obtained by the measurement unit 1010 in which measurement situation the measurement took place. In particular, a measurement situation will lead to a signature in the corresponding measurement results that differs from the signature obtained for a different measurement situation. For example, for a silicon cochlea measurement situations may be constituted by different sound sequences. Just the same, for visual sensors measurement situations may correspond to specific visual stimuli, like specific objects, movements, scenes and the like.

The possibility to discern measurement situations is improved for measurements made with varying measurement parameters. In this case, even if for a specific set of measurement parameters two measurement situations lead to similar measurement results, the two measurement situations will lead to different measurement results for another set of measurement parameters.

These concepts are used in the sensor device 1000 to ease the identification of measurement situations from the made measurements. To this end, during a training or calibration phase temporal series of measurement results are recorded that correspond to measurements by the measurement unit 1010. Each of these series of measurement results is generated by referring to the same variation pattern of measurement parameters that is applied for real measurements. Further, each series corresponds to a different measurement situation, i.e. each series should allow deduction of the measurement situation it refers to. To this end, it might be sufficient to carry out (or simulate) a single measurement of the respective measurement situation with the measurement unit 1010 and to record the results of the measurement. However, one might also obtain measurement results for a large number of variants of the measurement situation, like e.g. the same sequence of movements, but carried out by different persons, or the same object, but observed from different angles or in different light conditions. The series of measurement results will then correspond to characteristic features inherent to all measurement results.

In this manner, a dictionary of basic measurement situations can be formed and stored in the storage unit 1030 of the sensor device 1000, where it can be retrieved by the control unit 1020 as described below. Here, it should be noted that the generation of the plurality of temporal series of measurement results may be carried out by the sensor device 1000 during a calibration phase, i.e. by carrying out real measurements with the measurement unit 1010. However, preferably the temporal series of measurement results are generated by simulating the behavior of the measurement unit 1010 based on recorded or also simulated measurement situations. The simulation may be done by the control unit 1020. However, preferably the simulation is carried out on an external computer that stores the results in the storage unit 1030. In this manner, it will also be possible to supplement existing sensor devices 1000 with the dictionary of measurement situations retroactively. Thus, not only new devices, but also already existing devices can be improved.

The control unit 1020 is configured to compare measurements made by the measurement unit 1010 with the predetermined variation pattern of measurement parameters and the stored plurality of temporal series of measurement results, and, if said measurements match one of the stored temporal series of measurement results, to identify the measurement situation of the one stored temporal series of measurement results as the measurement situation of the measurements made by the measurement unit 1010. That is, the control unit 1020 gathers the measurement results of an actual measurement that was carried out while the control parameters were varied in the same manner as during generation of the pre-stored time series of measurement results. The control unit 1020 checks whether said actual measurement results match any of the measurement results of the stored dictionary. If so, the control unit 1020 deduces the measurement situation of the actual measurement from the measurement situation of the corresponding stored time series of measurement results.

In this manner, it is possible to determine in a comparably easy and reliable manner with a comparably low processing burden the measurement situation in which the measurements were made. This helps further processing and interpreting the obtained measurement.

Preferably, the measurement unit 1010 is a pixel array that comprises a plurality of event detection pixels 51, i.e. of pixels 51 as described above with respect to FIGS. 1 to 13. That is, each event detection pixel 51 is configured to receive light and to perform, based on the measurement parameters, for each event detection pixel 51 photoelectric conversion to generate event data as a measurement. Here, the event data indicate as an event the occurrence of intensity changes of the light above an event detection threshold. That is, the measurement unit 1010 generates for each event detection pixel 51 a stream of events that indicate the position of the intensity change above the event detection threshold as well as the time of the change. Further, the events may also indicate whether a positive or negative intensity change had happened (positive or negative polarity).

Similarly, also the plurality of temporal series of measurement results stored in the storage unit 1030 will be event streams. In this case, event streams of different variants of the same measurement situation may be combined by clustering algorithms that concentrate e.g. on events present in all event streams. The control unit 1020 can match these pre-stored event streams with the actually measured event stream by applying an appropriate distance measure for the data, like e.g. cosine distance/similarity, where for example for each event stream a vector is formed having pixel positions as rows and number of events per pixel as entries in the rows and the cosine of the angle between these vectors is determined.

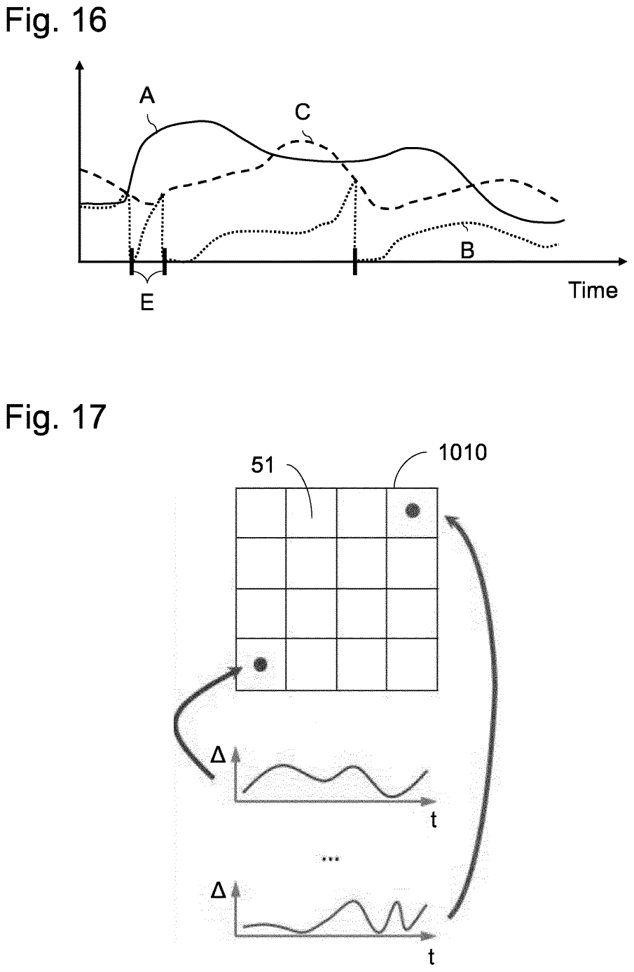

In this case, where the measurement unit 1010 is constituted as an EVS, one measurement parameter that can be varied is the event detection threshold. This is shown exemplarily in FIG. 16. Curve A in FIG. 16 represents the input signal, i.e. the light intensity on the respective event detection pixel 51. Curve B shows how difference charges are accumulated in the measurement unit 1010, e.g. in a subtraction section 83 as discussed with respect to FIG. 7 or 10. Curve C shows a pseudorandom variation of the event detection threshold. Every time the accumulated difference charge reaches the event detection threshold, i.e. every time curve B touches curve C, an event is detected. It is apparent that a different event detection threshold can lead to a different measurement result. Further, it is apparent that a different variation pattern will lead to a different event stream. Thus, while a variation of the event detection threshold helps to retrieve all available information, e.g. to trigger inactive pixels to read out information contained therein or too silence a pixel creating too much data, it is important that the same variation pattern is used for the generation of the event stream dictionary to be stored in the storage unit 1030 as well as for the actual measurement.

As is illustrated schematically with respect to FIG. 17, the control unit 1020 may not only be configured to set the same variation pattern to all event detection pixels 51 but may be configured to set different measurement parameters for different event detection pixels 51. This increases the retrievable information further and provides an increased flexibility for finding variation patterns for each event detection pixel 51 that allow an easy separation of measurement situations.

Besides the event detection threshold also other measurement parameters of an EVS can be changed for each of the event detection pixels 51. For example, pixel bandwidth and/or refractory period during which a pixel is inert after an event could be changed additionally or alternatively on a pixel-by-pixel basis. The pixel bandwidth is adjustable e.g. via a front end bias voltage (e.g. Vbias at transistor 92 of FIG. 6), a buffer bias or an amplifier bias. For low bandwidths, i.e. low currents, the SNR will improve, since there is less bandwidth to integrate noise, but the temporal resolution will be reduced, since fast motions are lost or attenuated, and vice versa for high bandwidths. The refractory periods of the single event detection pixels 51 can also be varied e.g. to reduce data rates in areas of high or redundant event activities for long refractory periods and to increase event detection rates for short refractory periods. Of course, it is to be understood that these are mere examples and that also other imaging parameters could be varied by the control unit 1020. In fact, any parameter can be used that has a direct or indirect influence on the outcome of the measurement.

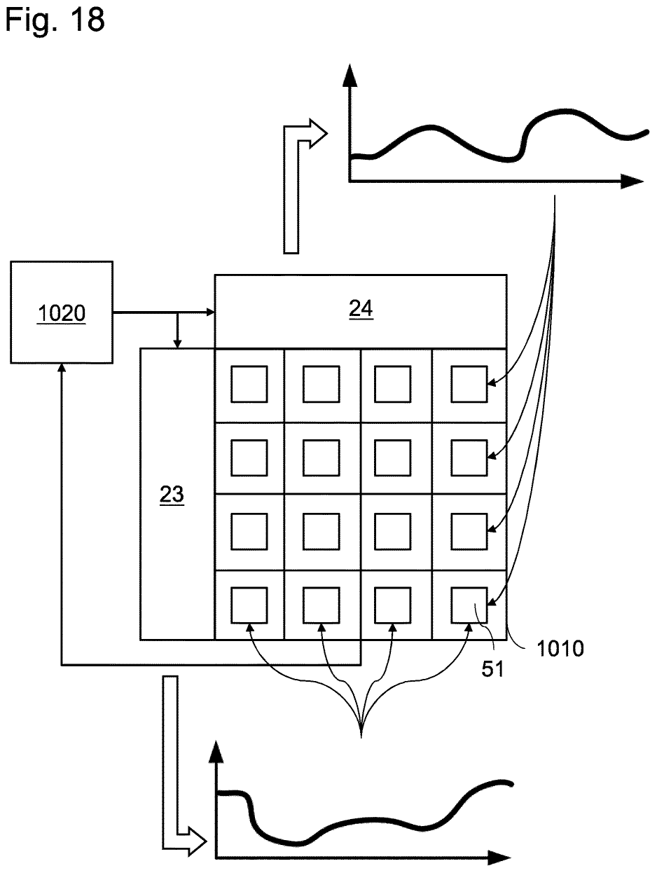

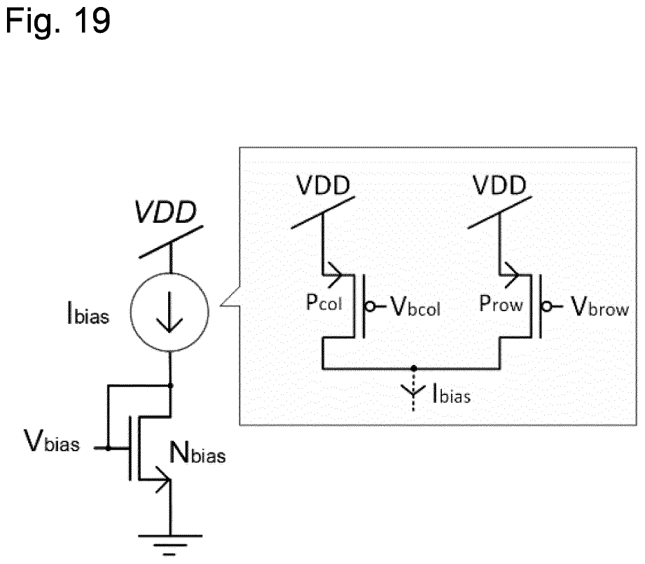

FIGS. 18 and 19 show exemplary how variations of measurement parameters per pixel can be achieved. As can be seen in FIG. 18, control signals of the event detection pixels 51 of the measurement unit 1010 can be applied row-by-row and column-by-column by using a plurality of row driving lines 23 and a plurality of column driving lines 24.

Each event detection pixel 51 is connected to a different pair of row setting line 23 and column setting line 24, which allows generating of different measurement parameter adjusting signals for each pixel by combining adjusting signals fed into the respective row setting lines 23 and column setting lines 24 by the control unit 1020. For example, bias voltages and/or currents used in the event detection pixels 51 can be adjusted by applying according voltages/currents to the row setting lines 23 and the column setting lines 24 and by using bias generators as known to a skilled person.

Thus, in principle, parameter values can be freely adjusted across the event detection pixels 51. This allows the control unit 1020 to set specific measurement parameter values to each of the event detection pixels 51 in a predetermined manner and to change the measurement parameter values continuously. For example, as shown in FIG. 18, a first temporal variation of a measurement parameter, like the event detection threshold, can be set to all event detection pixels 51 in the same row, and a different, second temporal variation of the same measurement parameter can be set to all event detection pixels 51 in the same column. The resulting variation pattern will be the superposition of the row-wise variation and the column-wise variation.

The adjusting signals of the control unit 1020 such as voltages or currents can directly control the desired change of measurement parameters (e.g. a piece-wise change as given by a lowpass filtered digital to analog converter) or control the change of parameters of an on-chip generated waveform (for example the amplitude, frequency or phase of a ramp, a sinusoidal, triangular voltage or the like).

Thus, current or voltage biases, which define the pixel characteristics/the measurement parameters, can be adjusted at each column and row independently through analog circuitry. The bias setting will be the same for the entire row and column distribution, but the various combinations of the two will result in multiple combinations of settings at each pixel location. This can be achieved as shown in FIG. 19, where the contribution of the column and row bias settings can be combined for a single event detection pixel 51 as the sum of two currents. Mismatch of the event detection pixel 51 itself can ensure more randomization and uniqueness per event detection pixel 51. Of course, although the above description was focused on the event detection threshold, any other measurement parameter can be adjusted in the same or a similar manner. Further, it might also be possible to control measurement parameters of event detection pixels 51 directly, i.e. by providing adjusting signals on a per-pixel basis.

In this manner, an appropriate variation pattern for the measurement parameters of each event detection pixel 51 can be chosen that simplifies detection of the measurement situation in which the measurement, i.e. image capturing took place. Possible measurement or imaging situation may for example be image capturing of a scene containing a specific class of objects. Thus, each measurement situation can be equated with the imaging of a certain class of objects, such as persons, men, women, cars, roadsides, animals, or a certain object, like a specific person or face (face recognition, iris recognition or the like), a specific car or number plate, a specific animal (automated cat flap) or the like. Identifying the measurement situation is then basically equivalent with solving a certain object classification or image segmentation task. The temporal series of measurement results are then obtained by image capturing of scenes containing (only) the respective object of the respective object class constituting a measurement situation. For example, if recognition of persons is desired, the temporal series of measurement results corresponding to a measurement situation showing a person can be obtained by generating or simulating measurement results for a given (large) number of videos showing that person. The resulting event streams can then be clustered in order to generate a characteristic event stream to which the event streams of actual measurements can be compared.

Alternatively or additionally, image capturing of a scene containing a specific movement or a specific class of movements can constitute a measurement situation. For example, in a gesture recognition task, each gesture may constitute a measurement situation. The temporal series of measurement results stored in the storage unit 1030 of the sensor device 1000 may in this case be obtained by imaging a plurality of different executions of the same gesture (or by simulating the imaging) and by clustering the resulting event stream, e.g. by counting only event detection patterns occurring in each event stream. Thus, a dictionary entry for each gesture can be generated against which the event stream in a gesture recognition task can be compared. Of course, in the same manner different movement sequences can be classified as different measurement situations, such as movements of cars (approach, removal, passing, parking, etc.) or humans.

The measurement situations may also be constituted by different classes of specifically composed scenes, i.e. instead of specific objects or classes thereof that are present in a scene, the general composition of the scene might be of interest. For example, for use in an autonomous driving application, measurement situations could be defined for the type of road that is driven (highway, rural road, city road, tunnel, etc.). In general, image reconstruction may be based on recognizing specifically composed scenes together with recognizing objects located in the scene.

Further, it is understood that the above examples of measurement situations are not limiting and that other measurement situations could be defined. In general, the definition of measurement situations will depend on the task to be executed based on the made measurements. The measurement situations will be chosen such that the task or substantial parts of the task can be executed by identifying which measurement situation(s) apply to a given measurement.

Here, the variation patterns applied to the different measurement parameters will (partly) decide whether or not different measurement situations can be distinguished. The control unit 1020 may therefore be configured to select the predetermined variation pattern from a plurality of predetermined variation patterns based on measurements made by the measurement unit 1010 and/or an indication which measurement situation is to be identified. Thus, the control unit 1020 may recognize based on current measurements, which identification of measurement situations is of predominant interest. For example, in an autonomous driving application, if a car drives in a crowded environment, such as a city, measurement situations concerning recognition of persons or close cars may be most relevant, while for highway driving approaching and passing cars may be most relevant. The control unit 1020 is then capable to select a given variation pattern suitable for the measurement situations to be identified. Instead of letting the control unit 1020 decide on the measurement situations of interest based on measurements, it is of course also possible to directly set the respective task/the respective measurement situations, e.g. by a user.

In the above process, selection of specific variation patterns comes with the selection of a corresponding plurality of temporal series of measurement results generated by using the selected variation pattern. Differently stated, for different tasks there may be different variation patterns, but the variation pattern used during the measurement and the variation pattern used for creation of the dictionary stored in the storage unit 1030 must be the same.

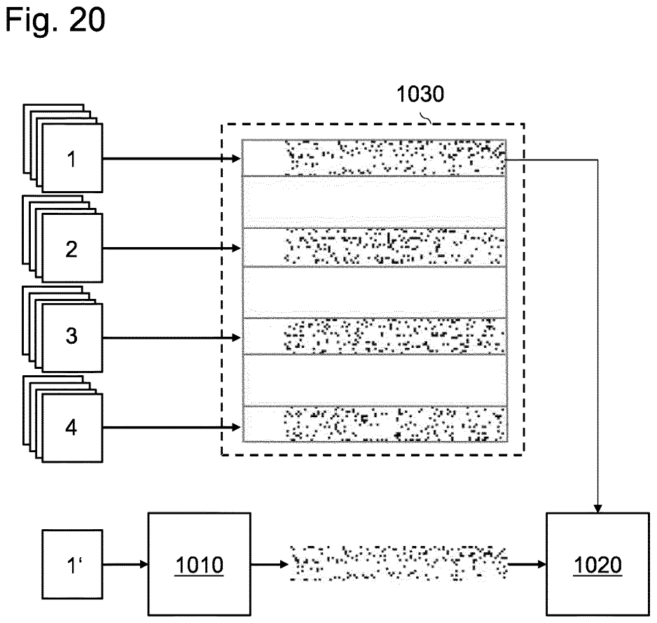

As explained above, for each task each temporal series of measurement results stored in the storage unit 1030 represents for each event detection pixel 51 the series of events that occurred at this event detection pixel 51 during a predetermined time interval for the respective measurement situation. This is again illustrated in a simplified manner in FIG. 20.

FIG. 20 shows four different measurement situations 1, 2, 3, and 4. The measurement situations may e.g. be different hand gestures or facial features. For each measurement situation a plurality of instances of the situation are observed, either in real or in simulation, while the measurement parameters are varied in a predetermined form and in the same manner for all measurement situations. For example, measurements can be simulated based on videos of a training data set, which videos show different variants of the measurement situation such as e.g. different hands showing one hand gesture in different manners.

For each of these measurement situations a characteristic event stream is generated, e.g. by using in principle known clustering algorithms, and stored in the storage unit 1030. This is exemplary shown in FIG. 20, in a simplified manner by the event maps where each line shows an event series for one event detection pixel 51 and each dot corresponds to the occurrence of an event. Thus, for each of the measurement situations 1, 2, 3, 4 a corresponding dictionary entry is generated and stored in the storage unit 1030.

When the measurement unit 1010 images a scene 1′ it generates an event stream that can also be represented by an event map, i.e. also here each line shows the event series of one event detection pixel 51 and each dot shows the occurrence of an event.

The control unit 1020 is then configured to compare the series of events generated by the measurement unit 1010 with each of the series of events represented by the temporal series of measurement results and to identify a match if said series of events generated by the measurement unit 1010 matches the series of events represented by one of the temporal series of measurement results. In the example of FIG. 20, the event stream of scene 1′ corresponds to the dictionary entry of measurement situation 1. Thus, the control unit 1020 can easily decide that the measurement situation of scene 1′ was measurement situation 1.

In this process, the control unit 1020 may be configured to encode the series of events of each of the temporal series of measurement results and the series of events generated by the measurement unit 1010 with the same encoding scheme, and to compare the encoded series of events. Thus, instead of using the mere stream of event data the control unit 1020 orders, selects, and/or transforms the event stream such as to obtain representations that can be most easily compared with each other. In this sense, already the event maps of FIG. 20 could be understood as encoded event streams as they present the occurred events in a comparable manner.

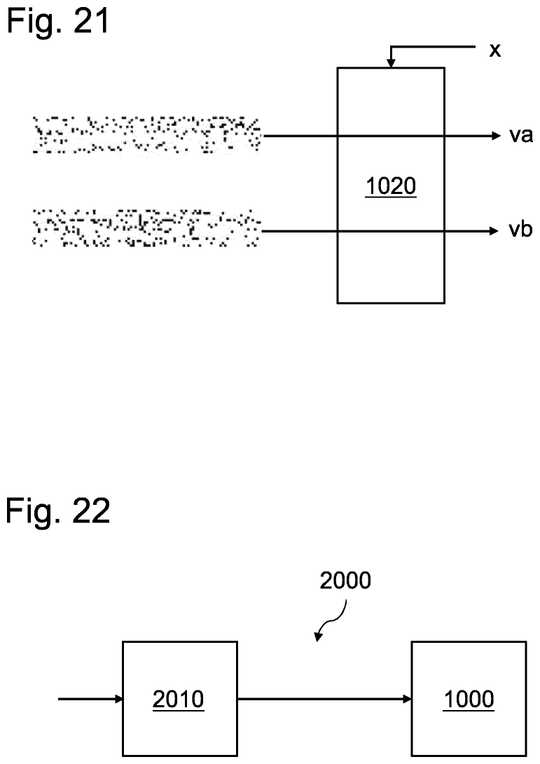

Moreover, as illustrated in FIG. 21 the control unit 1020 may encode event streams into a vector format, i.e. a linear series of numbers. A most simple example of such a vector format might be to indicate for each event detection pixel 51 and for each time instance occurrence of an event with 1 and non-occurrence of an event with 0. Instead of 1 for event occurrence, 1 may also indicate positive polarity events and −1 may indicate negative polarity events. Although this representation is rather simple, it will generate huge vectors that might be difficult to handle. Moreover, this representation might not be optimal for matching event streams. A condensed representation may for example count only the number of events per event detection pixels or may cluster events even differently. Also, a principle component analysis of the event data may be performed as encoding. Moreover, encoding schemes that lead to the best classification results might not be obvious for a human observer and might only be retrievable by a computer system via artificial intelligence processing. For example, a variational auto encoder might be used by the control unit 1020.

Vector matching may then be based on any known similarity measure. For example, a match may be assumed, if the vectors are sufficiently aligned, e.g. with a cosine similarity close to 1, e.g. between 0.8 and 1 or 0.9 and 1, or aligned and of the same size. Thus, encoding the event streams as a vector allows a comparison that is based on simple arithmetic operations and hence easy to process.

Here, the control unit 1020 may select the encoding scheme based on the used variation pattern of measurement parameters and/or based on the measurement situation to be identified. Thus, the encoding scheme is not fixed, but may be changed based on the task to be performed. This is indicated by external input x in FIG. 21. In particular, the control unit 1020 may determine the encoding scheme at the same time it determines the variation pattern to be used or the task to be carried out, i.e. the measurement situations of interest. This allows using an encoding that is optimized for the given task, i.e. that eases distinction between different measurement situation for the given task.

In the above description focus was made on sensor devices 1000 that use the plurality of temporal series of measurement results. In the following a sensor system 2000 for generating these data will be described. It should be noted that the various components of this system may be part of a single device, in particular even of the sensor device 1000. However, in general the components of the sensor system 2000 that were not described above (i.e. components different from the measurement unit 1010, the control unit 1020, and the storage unit 1030) will not be part of the sensor device 1000, and may e.g. be located at different positions. Moreover, also parts of the sensor device 1000 may be spatially separated from each other. For example, the storage unit 1030 may be located externally and information from the storage unit 1030 may be retrieved by the control unit 1020 by wireless communication.

The sensor system 2000 comprises, as highly schematically illustrated in FIG. 22, a sensor device 1000 as described above and a simulation unit 2010. Here, the simulation unit 2010 may be any computer, processor, software and/or hardware component that can carry out the functions of the simulation unit 2010 described in the following.

The simulation unit is configured to simulate measurements made by the measurement unit 1010 in different measurement situations and with different predetermined variation patterns of the measurement parameters of the measurement unit 1010. Thus, the simulation unit 2010 carries out the generation of the measurement values based on simulation. In particular, when operating with an EVS or other imaging system the simulation unit 2010 receives videos captured for specific measurement conditions and simulates the response the measurement unit 1010 would have given for the situation shown in the video.

The simulation unit 2010 is further configured to generate the plurality of temporal series of measurement results by simulation and to store the plurality of temporal series of measurement results in the storage unit 1030 of the sensor device 1000. Thus, the simulation unit 2010 also transforms measurement data into the dictionary data and stores them (or triggers storage thereof) in the storage unit 1030. Further the simulation unit 2010 may also be capable to provide the temporal series of measurement results obtained in this manner in encoded form to the storage unit 1030. Here, also differently encoded version of the temporal series of measurement results may be provided.

Based on the measurement input for simulation, like e.g. video data, the simulation unit 2010 is configured to determine the predetermined variation pattern and the plurality of temporal series of measurement results that are to be stored in the storage unit by a machine learning process. That is, the simulation unit 2010 applies a machine learning or artificial intelligence algorithm to the measurement input and decides based on this algorithm which possible variation pattern will produce the most significant plurality of temporal series of measurement results, i.e. which variation pattern will make a distinction between the different measurement situations represented by the input for simulation most reliable. Thus, the machine learning algorithm is used to optimize the selection of the variation pattern in view of the task that is to be fulfilled. In this manner, optimal variation patterns can be generated for different tasks, i.e. for different measurement situations that are to be distinguished.

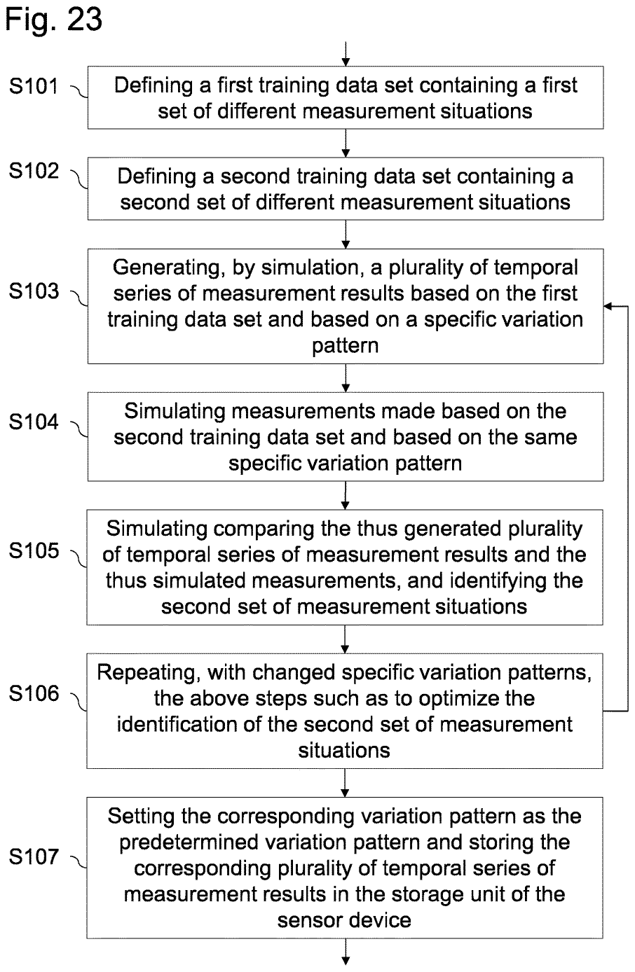

A particular example of such a machine learning process is discussed with respect to FIG. 23. In this example, the machine learning process comprises at S101 defining a first training data set containing a first set of different measurement situations, and at S102 defining a second training data set containing a second set of different measurement situations that at least partly differs from the first set.

Thus, two training data sets are defined that relate to the same class of measurement situations. Each training data set contains different instances of these measurement situations. For example, if gesture recognition is of interest, each training data set contains at least one, but preferably several videos of each gesture, i.e. different variants of each of the differing measurement situations. The data in the training data sets differ, however, at least partly from each other. In the gesture recognition example, also the second set of training data contains videos of gestures. However, the videos in the second training data set are at least in part different from the videos in the first training data set. Thus, the second training data set refers to a plurality of measurement situations that differ at least in part from the different measurement situations in the first set. Further, it has to be noted that it is not mandatory that all the measurement situations contained in the first training data set are also found in the second training data set. It is sufficient, if there is a sufficient overlap of measurement situations, for example 70% to 90%. For example, the first training data set may contain 50 different gestures, and the second training data set may contain 45 gestures of these 50 gestures and 10 additional gestures. It is merely necessary that the first training data set allows training of the system such that at least a part of the measurement situations of the second training data set can be recognized.

At S103 a plurality of temporal series of measurement results are generated by simulation based on the first training data set and based on a specific variation pattern. That is, for the data in the first training data set the operation of the measurement unit 1010 is simulated under the assumption that the measurement parameters are varied over time with the selected, specific variation pattern. For example, in the gesture recognition example, one specific variation pattern is set for each of the measurement parameters of each event detection pixel 51, and event streams are simulated for all the videos representing the first training data set. From these event streams a dictionary event stream, i.e. a temporal series of measurement results, is generated for each one of the measurement situations, e.g. for each different gesture.

At S104 measurements made by the measurement unit 1010 are simulated based on the second training data set and based on the same specific variation pattern. Thus, for each piece of training data in the second training data set a series of measurement results is generated with the same variation of measurement parameters as in the generation of the measurement situation dictionary. In the gesture recognition example, each video in the second training data set is used to simulate a corresponding event stream.

At S105 the operation of the control unit 1020 of comparing the thus generated plurality of temporal series of measurement results and the thus simulated measurements, and of identifying the second set of measurement situations is simulated. Thus, the capability of the control unit 1020 to identify correctly the measurement situations contained in the second training data set based on the information of the first training data set and the chosen variation of measurement parameters is checked. Differently stated, it is checked whether the dictionary generated from the first training data set is sufficient to determine the measurement situations included in the second training data set. In this manner the quality of the chosen variation pattern can be assessed.

At S106 the specific variation pattern is changed and the steps of generating a plurality of temporal series of measurement results and of simulating measurements are repeated such as to optimize the identification of the second set of measurement situations. For example, the variation pattern is randomly (or pseudo-randomly) changed over and over again, and the above-described simulations are repeated. From the change of the behavior of the (simulated) system advantageous changes of the variation pattern may be derived. In any case, the resulting correctness of the classification of measurement situations in the second training data set is checked, e.g. by merely counting correct identifications or by using any other appropriate loss function. For example, the rate of correct identifications of gestures in the second training data set (and/or its change with changing variation patterns) can be determined and used as feedback in finding an optimal variation pattern, i.e. a variation pattern of the measurement parameters that leads to dictionary entries that make a correct distinction between measurement situations most simple and reliable. This basic step of the machine learning algorithm can in principle be carried out by any artificial intelligence system that is capable thereof. In particular, neural networks might be used such as e.g. a model aware neural network.

Once the identification of the second set of measurement situations is optimized, the corresponding variation pattern is set at S107 as the predetermined variation pattern and the corresponding plurality of temporal series of measurement results are stored in the storage unit 1030 of the sensor device 1000. In this manner, for each task, i.e. for each measurement situation classification problem, an optimized variation pattern of measurement parameters can be found by machine learning. This optimized variation pattern and the corresponding dictionary entries can be used in real measurements to distinguish the different measurement situations for which the system was trained in a simple and reliable manner that needs only little processing power. Image reconstruction and/or classification tasks can therefore be reliably implemented based on event data generated with high temporal resolution (in principle in the μs-range) without the need to first generate data representations understandable for humans such as images of a scene.

In this manner, image reconstruction/classification can be carried out much faster than known from the prior art. Further, since the generation of dictionary data and the selection of the optimal variation pattern of the measurement parameters is carried out before the actual measurements, e.g. during factory calibration, the image reconstruction/classification will need only comparably little processing power. This allows to use the benefits described above also in sensor devices 1000 with reduced power supplies, like e.g. in mobile devices such as smart phones or the like.

In the above process, the simulation unit 2010 uses an artificial intelligence method to find the optimal variation pattern for measurement parameters based on optimizing the separability of different measurement situations. As described above, the control unit 1020 may not use the raw measurement data in the comparison, but may encode the measurements as well as the plurality of temporal series of measurement results to make the comparison less processing intensive. The effects of the manner of encoding can also be simulated, thus that separability of different measurement situations is optimized in view of the possible variation patterns as well as in view of the possible encoding schemes.

In particular, the simulation unit 2010 may determine the predetermined variation pattern and an encoding scheme for encoding the temporal series of measurement results and the measurements by the measurement unit 1010 by a machine learning process that optimizes the identification of the measurement situation by the control unit 1020, and sets the predetermined variation pattern and the encoding scheme for use in the control unit 1020. This can be achieved e.g. by modifying the process discussed above with respect to FIG. 23 such that the simulations of S103 to S105 are not only repeated for changing variation patterns, but also for changing encoding schemes and by taking encoded data into account when simulating comparing by the control unit 1020. Further, a variational autoencoder may be implemented in the simulation that is than trained together with the rest of the artificial intelligence process. Taking the encoding into account during training can further enhance the speed and reliability of the identification of measurement situations, while the processing power that is necessary to fulfill this task are further reduced.

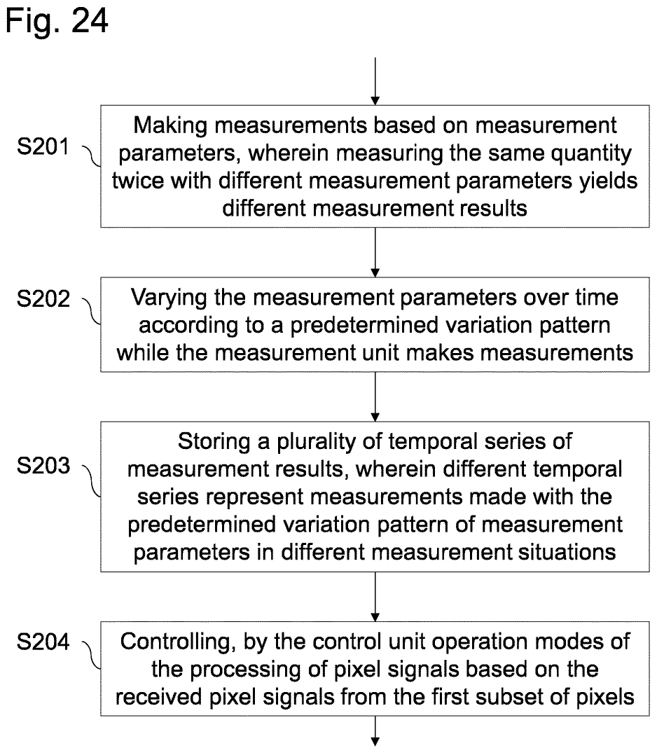

Above various implementations of the basic idea to use pre-stored dictionary entries of basic measurement situations in order to ease classification of such measurement situations during ongoing measurements has been discussed. The basic method underlying all these implementations is again summarized below with respect to FIG. 24.

At S201, measurements are made by a measurement unit 1010 based on measurement parameters, wherein measuring the same quantity twice with different measurement parameters may yield different measurement results.

At S202, the measurement parameters are varied over time by a control unit 1020 according to a predetermined variation pattern while the measurement unit 1020 makes measurements.

At S203, a plurality of temporal series of measurement results are stored in a storage unit 1030, wherein different temporal series represent measurements made with the predetermined variation pattern of measurement parameters in different measurement situations.

At S204 measurements made by the measurement unit 1010 with the predetermined variation pattern of measurement parameters are compared by the control unit 1020 with the stored plurality of temporal series of measurement results, and, if said measurements match one of the stored temporal series of measurement results, the measurement situation of the one stored temporal series of measurement results is identified as the measurement situation of the measurements made by the measurement unit 1010.

Thus, the basic idea is using a particular variation pattern of measurement parameters that allows an easy distinction of measurement situations based on basic dictionary entries obtained by using the same variation pattern. In this manner classification of measurement situations can be made simpler and more reliable. In particular, in the field of imaging image reconstruction/classification can be carried out in a reliable manner with the temporally highly resolved data of an event-based vision sensor/a dynamic vision sensor.

The technology according to the above (i.e. the present technology) is applicable to various products. For example, the technology according to the present disclosure may be realized as a device that is installed on any kind of moving bodies, for example, vehicles, electric vehicles, hybrid electric vehicles, motorcycles, bicycles, personal mobilities, airplanes, drones, ships, and robots.

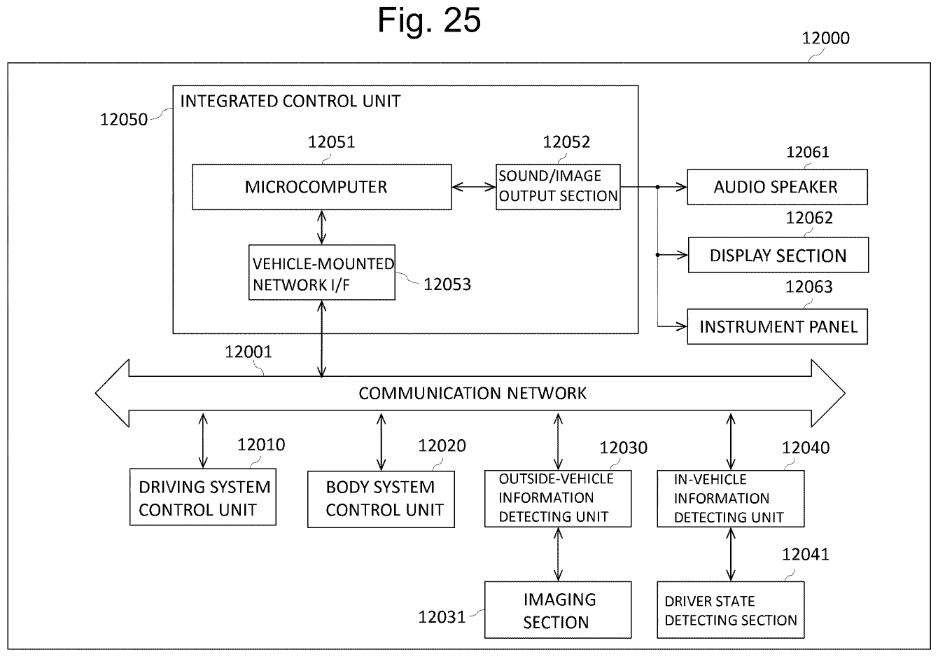

FIG. 25 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 25, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 25, an audio speaker 12061, a display section 12062, and an instrument panel 12063 are illustrated as the output device. The display section 12062 may, for example, include at least one of an on-board display and a head-up display.

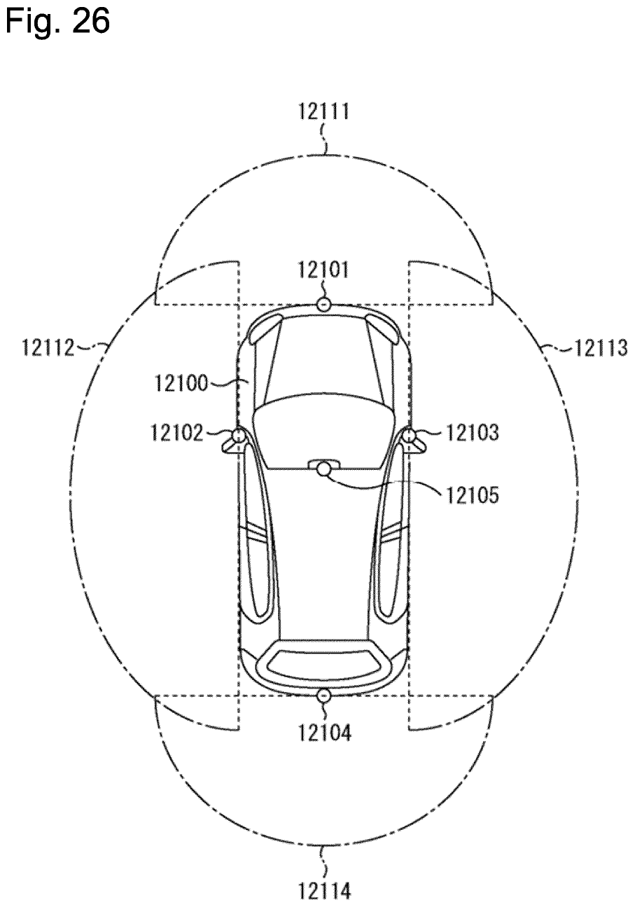

FIG. 26 is a diagram depicting an example of the installation position of the imaging section 12031.

In FIG. 26, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 26 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure is applicable has been described above. The technology according to the present disclosure is applicable to the imaging section 12031 among the above-mentioned configurations. Specifically, the sensor device 10 is applicable to the imaging section 12031. The imaging section 12031 to which the technology according to the present disclosure has been applied flexibly acquires event data and performs data processing on the event data, thereby being capable of providing appropriate driving assistance.

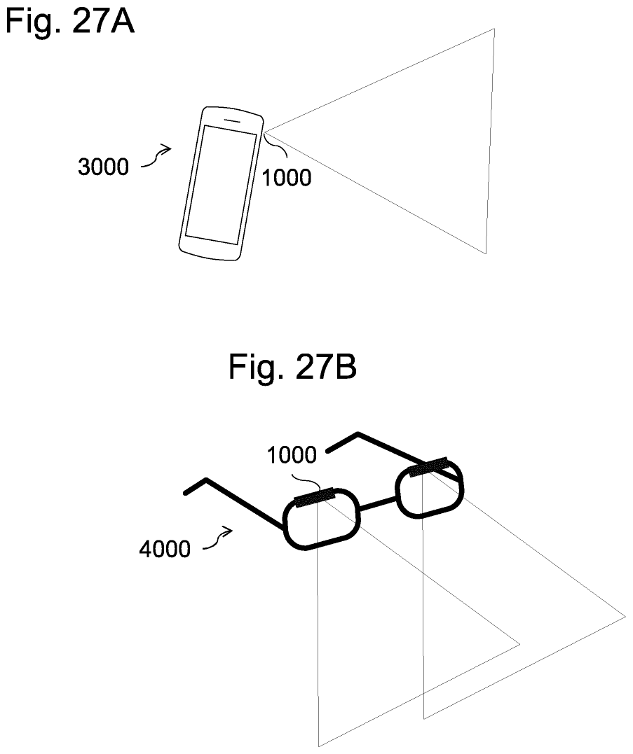

Further possible implementations of the sensor device 1000 are mobile devices 3000 such as cell phones, tablets, smart watches and the like as shown in FIG. 27A or head-mounted displays 4000 as shown in FIG. 27B. Further, the sensor device 1000 is useable in augmented and/or virtual reality applications/cameras or in surveillance systems like 360° cameras.

Note that, the embodiments of the present technology are not limited to the above-mentioned embodiment, and various modifications can be made without departing from the gist of the present technology.

Further, the effects described herein are only exemplary and not limited, and other effects may be provided.

Note that, the present technology can also take the following configurations.
[1] A sensor device (1000) comprising:
   a measurement unit (1010) that is configured to make measurements based on measurement parameters, wherein measuring the same quantity twice with different parameters may yield different measurement results;
   a control unit (1020) that is configured to vary the measurement parameters over time according to a predetermined variation pattern while the measurement unit (1010) makes measurements; and
   a storage unit (1030) that is configured to store a plurality of temporal series of measurement results, wherein different temporal series represent measurements made with the predetermined variation pattern of measurement parameters in different measurement situations; wherein
   the control unit (1020) is configured to compare measurements made by the measurement unit (1010) with the predetermined variation pattern of measurement parameters and the stored plurality of temporal series of measurement results, and, if said measurements match one of the stored temporal series of measurement results, to identify the measurement situation of the one stored temporal series of measurement results as the measurement situation of the measurements made by the measurement unit (1010).
[2] The sensor device (1000) according to [1], wherein
   the measurement unit (1010) comprises a plurality of event detection pixels (51) each configured to receive light and to perform, based on the measurement parameters, for each event detection pixel (51) photoelectric conversion to generate event data as a measurement; and
   the event data indicate as an event the occurrence of an intensity changes of the light above an event detection threshold.
[3] The sensor device (1000) according to [2], wherein
   each temporal series of measurement results represents for each event detection pixel (51) the series of events that occurred at this event detection pixel (51) during a predetermined time interval for the respective measurement situation;
   the control unit (1020) is configured to compare the series of events generated by the measurement unit (1010) with each of the series of events represented by the temporal series of measurement results and to identify a match if said series of events generated by the measurement unit (1010) matches the series of events represented by one of the temporal series of measurement results.
[4] The sensor device (1000) according to [3], wherein
   the control unit (1020) is configured to encode the series of events of each of the temporal series of measurement results and the series of events generated by the measurement unit (1010) with the same encoding scheme, and to compare the encoded series of events.
[5] The sensor device (1000) according to [4], wherein
   the control unit (1020) is configured to select the encoding scheme based on the used variation pattern of measurement parameters and/or based on the measurement situation to be identified.
[6] The sensor device (1000) according to any one of [2] to [5], wherein
   the control unit (1020) is configured to set different measurement parameters for different event detection pixels (51); and
   the measurement parameters for each event detection pixel (51) include at least one of the event detection threshold, a pixel bandwidth, and a refractory period during which a pixel is inert after an event.
[7] The sensor device (1000) according to any one of [2] to [6], wherein
   the control unit (1020) is configured to identify as the measurement situation one of the list of image capturing of a scene containing a specific class of objects, image capturing of a scene containing a specific class of movements, and image capturing of classes of specifically composed scenes.
[8] The sensor device (1000) according to any one of [1] to [7], wherein
   the control unit (1020) is configured to select the predetermined variation pattern from a plurality of predetermined variation patterns based on measurements made by the measurement unit and/or an indication which measurement situation is to be identified.
[9] A sensor system (2000) comprising
   the sensor device (1000) according to any one of [1] to [8]; and
   a simulation unit (2010) that is configured to simulate measurements made by the measurement unit (1010) in different measurement situations and with different predetermined variation patterns of the measurement parameters of the measurement unit (1010); wherein
   the simulation unit (2010) is configured to generate the plurality of temporal series of measurement results by simulation and to store the plurality of temporal series of measurement results in the storage unit (1030) of the sensor device (1000).
[10] The sensor system (2000) according to [9], wherein
   the simulation unit (2010) is configured to determine the predetermined variation pattern and the plurality of temporal series of measurement results that are to be stored in the storage unit by a machine learning process.
[11] The sensor system (2000) according to [10], wherein
   the machine learning process comprises
      defining a first training data set containing a first set of different measurement situations,
      defining a second training data set containing a second set of different measurement situations that at least partly differs from the first set,
      generating, by simulation, a plurality of temporal series of measurement results based on the first training data set and based on a specific variation pattern,
      simulating measurements made by the measurement unit (1010) based on the second training data set and based on the same specific variation pattern,
      simulating the operation of the control unit (1020) of comparing the thus generated plurality of temporal series of measurement results and the thus simulated measurements, and of identifying the second set of measurement situations,
      repeating, with changed specific variation patterns, the steps of generating a plurality of temporal series of measurement results and of simulating measurements such as to optimize the identification of the second set of measurement situations, and
      once the identification of the second set of measurement situations is optimized, setting the corresponding variation pattern as the predetermined variation pattern and storing the corresponding plurality of temporal series of measurement results in the storage unit (1030) of the sensor device (1000).
[12] The sensor system (2000) according to any one of [9] to [11], wherein
   the simulation unit (2010) is configured to determine the predetermined variation pattern and an encoding scheme for encoding the temporal series of measurement results and the measurements by the measurement unit (1010) by a machine learning process that optimizes the identification of the measurement situation by the control unit (1020), and to set the predetermined variation pattern and the encoding scheme for use in the control unit (1020).
[13] A method for operating a sensor device (1000), the method comprising:
   by a measurement unit (1010), making measurements based on measurement parameters, wherein measuring the same quantity twice with different measurement parameters may yield different measurement results;
   by a control unit (1020), varying the measurement parameters over time according to a predetermined variation pattern while the measurement unit (1020) makes measurements;
   storing in a storage unit (1030) a plurality of temporal series of measurement results, wherein different temporal series represent measurements made with the predetermined variation pattern of measurement parameters in different measurement situations; and
by the control unit (1020), comparing measurements made by the measurement unit (1010) with the predetermined variation pattern of measurement parameters and the stored plurality of temporal series of measurement results, and, if said measurements match one of the stored temporal series of measurement results, identifying the measurement situation of the one stored temporal series of measurement results as the measurement situation of the measurements
   made by the measurement unit (1010).

1. A sensor device comprising:
a measurement unit that is configured to make measurements based on measurement parameters, wherein measuring the same quantity twice with different parameters may yield different measurement results;
a control unit that is configured to vary the measurement parameters over time according to a predetermined variation pattern while the measurement unit makes measurements; and
a storage unit that is configured to store a plurality of temporal series of measurement results, wherein different temporal series represent measurements made with the predetermined variation pattern of measurement parameters in different measurement situations; wherein
the control unit is configured to compare measurements made by the measurement unit with the predetermined variation pattern of measurement parameters and the stored plurality of temporal series of measurement results, and, if said measurements match one of the stored temporal series of measurement results, to identify the measurement situation of the one stored temporal series of measurement results as the measurement situation of the measurements made by the measurement unit.

2. The sensor device according to claim 1, wherein
the measurement unit comprises a plurality of event detection pixels each configured to receive light and to perform, based on the measurement parameters, for each event detection pixel photoelectric conversion to generate event data as a measurement; and
the event data indicate as an event the occurrence of an intensity changes of the light above an event detection threshold.

3. The sensor device according to claim 2, wherein
each temporal series of measurement results represents for each event detection pixel the series of events that occurred at this event detection pixel during a predetermined time interval for the respective measurement situation; and
the control unit is configured to compare the series of events generated by the measurement unit with each of the series of events represented by the temporal series of measurement results and to identify a match if said series of events generated by the measurement result matches the series of events represented by one of the temporal series of measurement results.

4. The sensor device according to claim 3, wherein
the control unit is configured to encode the series of events of each of the temporal series of measurement results and the series of events generated by the measurement unit with the same encoding scheme, and to compare the encoded series of events.

5. The sensor device according to claim 4, wherein
the control unit is configured to select the encoding scheme based on the used variation pattern of measurement parameters and/or based on the measurement situation to be identified.

6. The sensor device according to claim 2, wherein
the control unit is configured to set different measurement parameters for different event detection pixels; and
the measurement parameters for each event detection pixel include at least one of the event detection threshold, a pixel bandwidth, and a refractory period during which a pixel is inert after an event.

7. The sensor device according to claim 2, wherein
the control unit is configured to identify as the measurement situation one of the list of image capturing of a scene containing a specific class of objects, image capturing of a scene containing a specific class of movements, and image capturing of classes of specifically composed scenes.

8. The sensor device according to claim 1, wherein
the control unit is configured to select the predetermined variation pattern from a plurality of predetermined variation patterns based on measurements made by the measurement unit and/or an indication which measurement situation is to be identified.

9. A sensor system comprising
the sensor device according to claim 1; and
a simulation unit that is configured to simulate measurements made by the measurement unit in different measurement situations and with different predetermined variation patterns of the measurement parameters of the measurement unit; wherein
the simulation unit is configured to generate the plurality of temporal series of measurement results by simulation and to store the plurality of temporal series of measurement results in the storage unit of the sensor device.

10. The sensor system according to claim 9, wherein
the simulation unit is configured to determine the predetermined variation pattern and the plurality of temporal series of measurement results that are to be stored in the storage unit by a machine learning process.

11. The sensor system according to claim 10, wherein
the machine learning process comprises
defining a first training data set containing a first set of different measurement situations,
defining a second training data set containing a second set of different measurement situations that at least partly differs from the first set,
generating, by simulation, a plurality of temporal series of measurement results based on the first training data set and based on a specific variation pattern,
simulate measurements made by the measurement unit based on the second training data set and based on the same specific variation pattern,
simulate the operation of the control unit of comparing the thus generated plurality of temporal series of measurement results and the thus simulated measurements, and of identifying the second set of measurement situations,
repeating, with changed specific variation patterns, the steps of generating a plurality of temporal series of measurement results and of simulating measurements such as to optimize the identification of the second set of measurement situations, and
once the identification of the second set of measurement situations is optimized, setting the corresponding variation pattern as the predetermined variation pattern and storing the corresponding plurality of temporal series of measurement results in the storage unit of the sensor device.

12. The sensor system according to claim 9, wherein
the simulation unit is configured to determine the predetermined variation pattern and an encoding scheme for encoding the temporal series of measurement results and the measurements by the measurement unit by a machine learning process that optimizes the identification of the measurement situation by the control unit, and to set the predetermined variation pattern and the encoding scheme for use in the control unit.

13. A method for operating a sensor device, the method comprising:
by a measurement unit, making measurements based on measurement parameters, wherein measuring the same quantity twice with different measurement parameters may yield different measurement results;
by a control unit, varying the measurement parameters over time according to a predetermined variation pattern while the measurement unit makes measurements;
storing in a storage unit a plurality of temporal series of measurement results, wherein different temporal series represent measurements made with the predetermined variation pattern of measurement parameters in different measurement situations; and
by the control unit, comparing measurements made by the measurement unit with the predetermined variation pattern of measurement parameters and the stored plurality of temporal series of measurement results, and, if said measurements match one of the stored temporal series of measurement results, identifying the measurement situation of the one stored temporal series of measurement results as the measurement situation of the measurements made by the measurement unit.
